(19) United States
(12) Patent Application Publication
(10) Pub. No.: US 2006/0019712 A1
(43) Pub. Date: Jan. 26, 2006

(54) Calibration apparatus for smart antenna and method thereof

(76) Inventor: Seung-Won Choi, Seoul (KR)

Correspondence Address: MAYER, BROWN, ROWE & MAW LLP, 1909 K STREET, N.W., WASHINGTON, DC, 20006, US

(21) Appl. No.: 11/229,310

(22) Filed: Sep. 19, 2005

Related U.S. Application Data
(63) Continuation-in-part of application No. 10/491,724, filed on Apr. 5, 2004.

(51) Int. Cl. H04M 1/00

(52) U.S. Cl. 455/562.1

(57) ABSTRACT

This invention is related to the calibration apparatus and method for compensating the phase characteristics in the receiving and transmitting signal paths of array antenna system, especially adaptive array antenna system operating as the base station system. The objective of this invention is to provide the calibration apparatus and method for the array antenna system to be able to compensate its phase differences or irregularities without any restrictions on the array structure or position of additional antenna or antenna toplogies while the array antenna system is in its operational mode such that the signals used by the subscribers are received or transmitted together with the signals used for the calibration. In this invention the phase delay between the additional antenna element and each of the antenna elements of the array antenna system is measured in advance of the calibration procedure to be used when the phase differences or irregularities are measured during the calibration procedure. The test signals used for the calibration is distinguishable from the signals used by the subscribers. Furthermore, each of the transmitting calibration signals itself is distinguishable from one another when the plural transmitting signal paths are to be calibrated simultaneously.

### CROSS REFERENCE TO RELATED APPLICATION

This application is a continuation-in-part of U.S. Ser. No. 10/491,724, filed Apr. 5, 2004, which is the National Phase of PCT Application No. PCT/KR01/01939, filed Nov. 14, 2001. These applications, in its entirety, is incorporated herein by reference.

### FIELD OF THE INVENTION

This invention is related to calibration apparatus and its method for array antenna system, especially for adaptive array antenna system. More specifically, this invention is related to calibration apparatus and its method for compensating differences or irregularities of phase characteristics in said adaptive array antenna system for both receiving and transmitting mode.

### DESCRIPTION OF RELATED ARTS

Said adaptive array antenna system denotes a communication system that optimizes its antenna beam pattern utilizing a predetermined adaptive beamforming algorithm based on the information acquired from the received signals at each of antenna elements. Although this invention is focued mainly on said adaptive array antenna system, this invention is also valid for said array antenna system of which the beam pattern is not adaptively optimized by said adaptive algorithm but is determned by selecting procedure from preserved values.

The applicants of this invention have submitted following documents, which are related to said adaptive array antenna system, to Korean patent office for patents: 1996-12171, 1996-12172, 1996-17931, 1996-25377, 1997-73901, 1999-58065, 2000-30655, 2000-30656, 2000-30657, 2000-30658, 2001-14671, 2001-20971, 2001-7008066, 2001-62792, 2001-63543, 2001-64498, 2001-67953, 2001-71055, 2001-71284, and 2001-77674.

Said adaptive array antenna system is to provide each subscriber an ideal beam pattern, which has its maximum gain along the direction of the target subscriber maintaining its gain at as low level as possible to the other directions, utilizing a beamforming parameter such as weight vector that is obtained from received signals at each snapshot. Said snapshot denotes a time interval for which said beamforming parameter is updated. Said ideal beam pattern should be provided for transmitting mode as well as for receiving mode of said adaptive array antenna system.

However, it is not easy to provide said ideal beam pattern to said adaptive array antenna system in even said receiving mode because of many techinical restrictions. In order to provide a beam pattern that is close to said ideal beam pattern in said trnasmitting mode as well as in said receiving mode, said phase characteristics of the signal path associated with each of antenna elements in said adaptive array antenna system should be equalized through a proper compensation procedure. The compensation procedure described above is referred to as “calibration”. In many cases, calibration may include said compensation procedure for magnitude characteristics as well as for said phase characteristics, though our main interest lies in said compensation of phase characteristics in this invention. It does not mean that techiniques disclosed in this invention is valid ony for said compensation of phase characteristics. It is valid for said compensation of both magnitude and phase characteristics of the signal path associated with each of antenna elements in said adaptive array antenna system.

The ultimate goal of said calibration in this invention is to equalize said beam pattern for said transmitting mode to that for said receiving mode. In general, said beam forming parameter for providing a transmitting beam pattern is based on said beam forming parameter that has been obtained during said receiving mode for the same time slot. Therefore, assuming said beam forming parameter for said receiving mode provides a nice beam pattern that is close to said ideal beam pattern, the same beam pattern can be provided during said transmitting mode if the differences and/or irregularities in said phase characteristics among signal paths associated with corresponding antenna elements in said adaptive array antenna system are properly resolved through said calibration procedure.

Prior art related to said calibration can be found from “Adaptive Array Antenna Transceiver Apparatus” (Pub. No.: US2001/0005685 A1, Pub. Date: Jun. 28, 2001.) by K. Nishimori, et al. This prior art is concerned with “an adaptive array antenna transceiver apparatus for automatically calibrating the amplitude and phase differences between branches of the antenna for the respective transmitter and receiver”.

Above prior art has a restriction on the location of additional antenna according to given array antenna structure as illustrated in FIG. 1 and 2.

FIG. 1 illustrates planar drawings showing the arrangement of the antenna elements and the additional antenna according to the prior art. As illustrated in FIG. 1, in the case that the antenna elements arranged on one line are equally spaced, the additional antenna 128 should be disposed at a position in the middle of two antenna elements 111 such that the distances d between each of the antenna elements 111 on the two branches that are the object of calibration and the additional antenna 128 are equal. Therefore, it is the restriction in the prior art that said additional antenna should be located at the very center of the antenna elements in said adaptive array antenna system. It also implies that N-1 additional antennas would be needed in the case of linear array system consisting of N antenna elements.

FIG. 2 illustrates planar drawings showing the arrangement of the antenna elements and the additional antenna. As shown in FIG. 2, in the case of cylinderical array anstenna system in which antenna elements 111 are located along the circle with equal spacing, said additional antenna 128 should be positioned at the center of the circle such that distance d between said additonal antenna 128 and each of the to-be-calibrated antennas 111 is all the same. It is, however, very difficult to find said center of the circle in said cylinderical array system operating in RF (radio Frequency) band. Consequently, it is the most serious hindrance in prior art that said additional antenna should be installed at the exact position in such a way that the distance between said additional antenna and each of acting antenna elements is the same for the phase delay between said additional antenna and each of acting antenna elements to be the same as one another. Furthermore, accroding to said prior art shown in FIG. 2, said additional antenna should be omni-directional.

As a conclusion, it is an inherent problem in said prior art that the position where the additional antenna 128 is disposed and the number of the additional antenna 128 must be determined depending on the position and the number of the antenna elements 111 that form the array antenna

### SUMMARY OF THE INVENTION

It is the objective of this invention, which has been proposed to resolve the problems in the prior art, to provide calibration apparatus of said array antenna system and its method for compensating the differences of said phase characteristics in the signal paths associated with each of antenna elements without any restriction on the architechure or topology of said array antenna.

It is another objective of this invention, which has been proposed to resolve the problems in the prior art, to provide calibration apparatus of said array antenna system and its method for compensating the differences of said phase characteristics in the signal paths associated with each of antenna elements without any restriction on the architechure or position of said additional antenna element.

It is another objective of this invention, which has been proposed to resolve the problems in the prior art, to provide calibration apparatus of said array antenna system and its method for compensating the differences of said phase characteristics in the signal paths associated with each of antenna elements without any restriction on whether or not said array antenna system is in active mode.

The goal in the calibration procedure discussed above can be achieved in this invention due to the fact that the phase delay between said additional antenna and each of antenna elements to be calibrated is measured in advance and the value of said phase delay that has been measured in advance is properly reflected in the calibration procedure of compensating the phase delay characteristics among signal paths associated with each of antenna elements. Also, the goal in the calibration procedure discussed above can be achieved in this invention due to another fact that the signal transmitted or received at said additional antenna element for the calibration function is distinguishable from the other signals used for the original purposes during the normal operation of said array antenna system.

In accordance with one aspect of the present invention, there is provided a calibration apparatus of an adaptive array antenna system, the calibration apparatus comprising: calibrator means that generates the “Rx calibration signal” and performs the calibration procedure based on the “Rx calibration signal” received at each of receiving antenna elements of the array antenna means; additional antenna means that transmits the “Rx calibration signal” to the receiving antenna elements of the array antenna means with an arbitrary arrangement and spacing in a freuqency band of receiving RF (radio frequency); and array antenna means with an arbitrary arrangement and spacing of antenna elements that transfers the “Rx calibration signal”, which have been received from the additional antenna means, to the calibrator means, wherein the calibration procedure is performed by a step of compensating the differences or irregularities in phase characteristics at each of signal paths associated with each of the receiving antenna elements of the array antenna means utilizing φ_{RX, n} (phase delay between each of receiving antenna elements of the array antenna means and each corresponding port of the calibrator means) that is related with the two sets of phase delay values φ″_{RX, n} (phase delay between the additional antenna means and the calibrator means) and φ′_{RX, n} (phase delay between the additional antenna means and each of the receiving antenna elements of the antenna array means) by a mathematical equation φ_{RX, n}=φ″_{RX, n}−φ′_{RX, n} where φ′_{RX, n} is obtained in advance of the calibration procedure.

In accordance with another aspect of the present invention, there is provided a calibration method of an adaptive array antenna system including calibrator means, additional antenna means, and array antenna means with an arbitrary arrangement and spacing—the calibrator means generates the “Rx calibration signal” and performs the calibration procedure based on the “Rx calibration signal” received at each of receiving antenna elements of the array antenna means, the additional antenna means transmits the “Rx calibration signal” to the receiving antenna elements of the array antenna means with an arbitrary arrangement and spacing in a freuqency band of receiving RF (radio frequency), and the array antenna means transfers the “Rx calibration signal” which have been received from the additional antenna means, to the calibrator means—the calibration procedure comprises a step of compensating the differences or irregularities in phase characteristics at each of signal paths associated with each of the receiving antenna elements of the array antenna means utilizing φRX, n (phase delay between each of receiving antenna elements of the array antenna means and each corresponding port of the calibrator means) that is related with the two sets of phase delay values φ″_{RX, n} (phase delay between the additional antenna means and the calibrator means) and φ′_{RX, n} (phase delay between the additional antenna means and each of the receiving antenna elements of the antenna array means) by a mathematical equation φ_{RX, n}=φ″_{RX, n-φ′}_{RX, n} where φ′_{RX, n} is obtained in advance of the calibration procedure.

In accordance with further another aspect of the present invention, there is provided a calibration apparatus of an adaptive array antenna system, the calibration apparatus comprising: calibrator means that generates the “Tx calibration signal” and performs the calibration procedure based on the “Tx calibration signal” received at additional antenna means; array antenna means with an arbitrary arrangement and spacing of antenna elements that transmits the “Tx calibration signal”, which has been generated at the calibrator means, to the additional antenna means; and additional antenna means that receives the “Tx calibration signal” from the transmitting antenna elements of the array antenna means with an arbitrary arrangement and spacing in a freuqency band of transmitting RF (radio frequency), wherein the calibration procedure is performed by a step of compensating the differences or irregularities in phase characteristics at each of signal paths associated with each of the transmitting antenna elements of the array antenna means utilizing φ_{TX, n} (phase delay between calibrator means and each of transmitting antenna elements of the array antenna means and) that is related with the two sets of phase delay values φ″_{TX, n} (phase delay between the calibrator means and the additional antenna means) and φ′_{TX, n} (phase delay between each of the transmitting antenna elements of the antenna array means and the additional antenna means) by a mathematical equation φ_{TX, n}=φ″_{TX, n}−φ′_{TX, n} where φ′_{TX, n} is obtained in advance of the calibration procedure.

In accordance with still further another aspect of the present invention, there is provided a calibration method of an adaptive array antenna system including calibrator means, additional antenna means, and array antenna means with an arbitrary arrangement and spacing—the calibrator means generates the “Tx calibration signal” and performs the calibration procedure based on the “Tx calibration signal” received at the additional antenna means, each of the transmitting antenna elements of the array antenna means transmits the “Tx calibration signal” to the additional antenna means in a freuqency band of transmitting RF (radio frequency) of the array antenna system, and the “Tx calibration signal” received at the additional antenna means is transferred to the calibrator means after the frequency band is converted from the transmitting RF to the base band—the calibration procedure comprises a step of compensating the differences or irregularities in phase characteristics at each of signal paths associated with each of the receiving antenna elements of the array antenna means utilizing φ_{TX, n} (phase delay between each of receiving antenna elements of the array antenna means and each corresponding port of the calibrator means) that is related with the two sets of phase delay values φ″_{TX, n} (phase delay between the additional antenna means and the calibrator means) and φ′_{TX, n} (phase delay between the additional antenna means and each of the receiving antenna elements of the antenna array means) by a mathematical equation φ_{TX, n}=φ″_{TX, n}−φ′_{TX, n} where φ′_{TX, n} is obtained in advance of the calibration procedure.

### BRIEF DESCRIPTION OF THE DRAWINGS

FIG. 1 and FIG. 2 illustrate planar drawings showing the arrangement of the antenna elements and the additional antenna according to the prior art.

FIG. 3A illustrates a block diagram of a receiving array antenna system which adopts a single antenna element connected with the plural antenna channels through a divier. This figure shows how the phase characteristics of each of receiving antenna paths can be measured.

FIG. 3B illustrates a block diagram of a transmitting array antenna system which adopts a single antenna element connected with the plural antenna channels through a combiner. This figure shows how the phase characteristics of each of transmitting antenna paths can be measured.

FIG. 4 illustrates the phase characteristics of an array antenna system consisting of 6 antenna elements. Letting the phase characteristic along one antenna element, which has been arbitrarily selected, be zero, the phase characteristics along the other 5 antenna elements, A, B, C, D, and E, are measured to be all different as shown in FIG. 4.

FIG. 5 illustrates a block diagram of said calibration apparatus for said array antenna system in receiving mode according to the first application example of this invention.

FIG. 6 shows how to measure the phase characteristic of the signal path associated with each of antenna elements of said array antenna system in receiving mode shown in FIG. 5.

FIGS. 7A, 7B, 7C, and 7D show the calibration procedure performed in said calbration apparatus of receiving array antenna system according to the first application example of this invention.

FIG. 8 illustrates a block diagram of said calibration apparatus for said array antenna system in transmitting mode according to the first application example of this invention.

FIG. 9 shows how to measure the phase characteristic of the signal path associated with each of antenna elements of said array antenna system in transmitting mode shown in FIG. 8.

FIGS. 10A, 10B, 10C, and 10D show the calibration procedure performed in said calbration apparatus of transmitting array antenna system according to the first application example of this invention.

FIG. 11 illustrates a block diagram of said calibration apparatus for said array antenna system in receiving mode according to the second application example of this invention.

FIG. 12 illustrates a block diagram of said calibration apparatus for said array antenna system in transmitting mode according to the second application example of this invention.

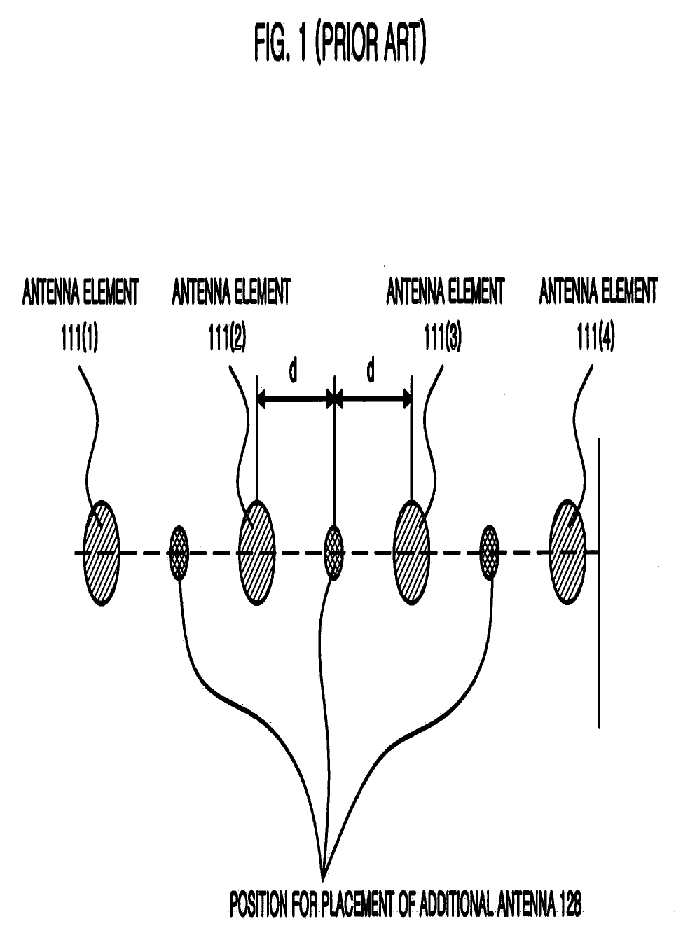

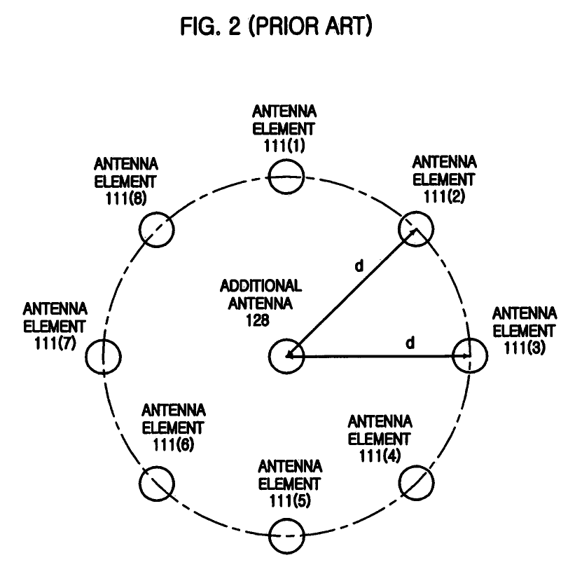

### DETAILED DESCRIPTION OF THE PREFERRED EMBODIMENT OF THE INVENTION

The objectives, special features, and advantages described in this invention will be more clarified through detailed explanations and figures given below. We describe the first application example of this invention as a preferred embodiment using proper figures as follows.

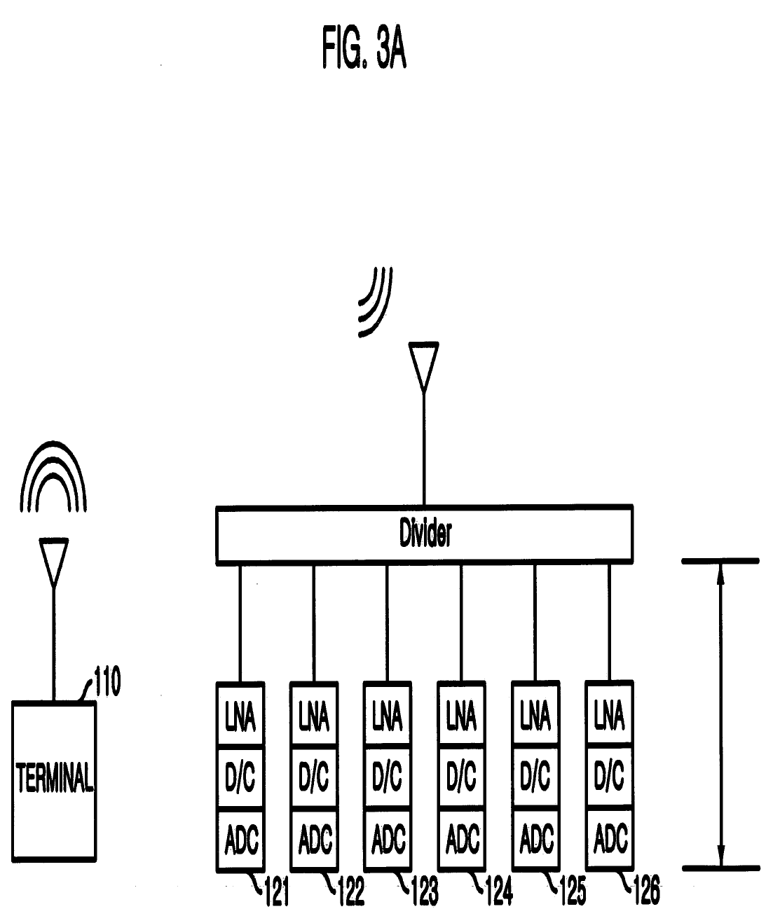

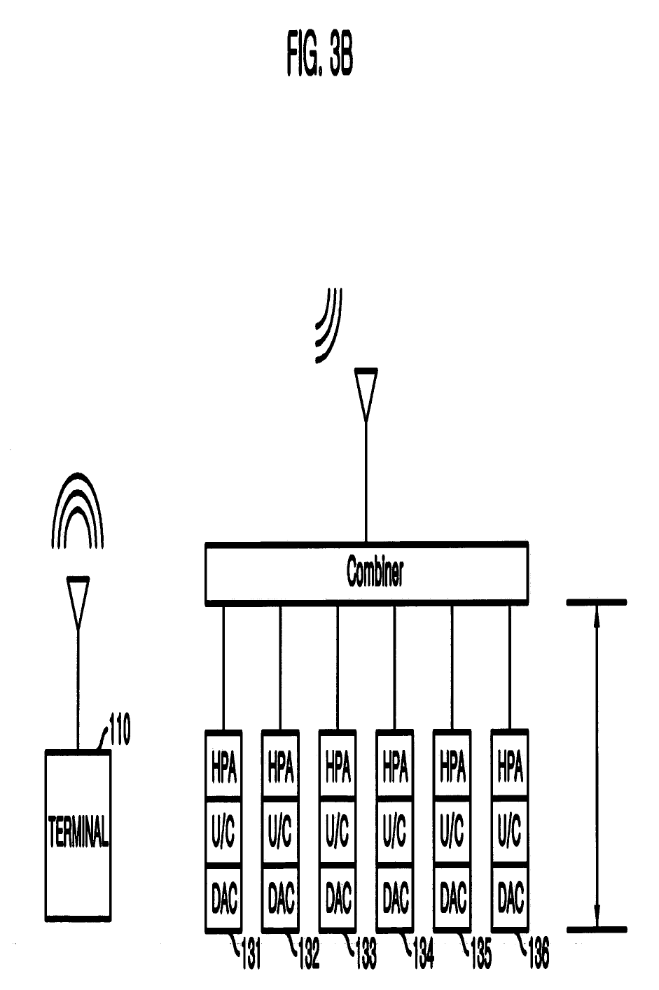

FIG. 3A illustrates a block diagram of a general array antenna system which describes the conceptual view of calibration. Using the system structure shown in FIG. 3A, the different characteristics of each of antenna channels can be measured.

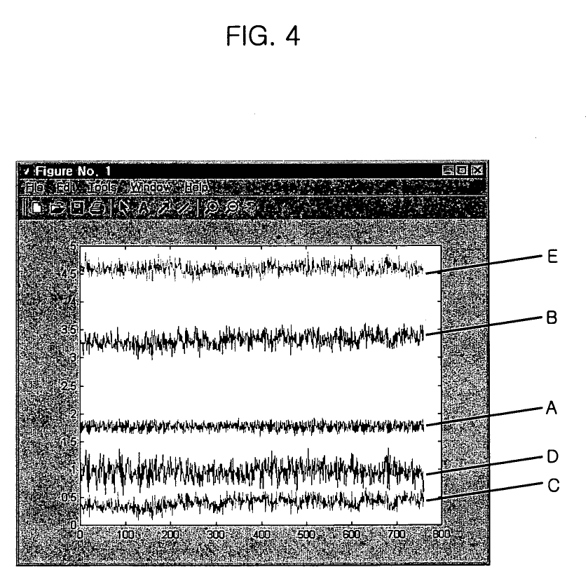

As shown in FIG. 3A, the differences of phase characteristics in each of antenna channels (the phase differences will be refered to as “phase error” from now on) can be obtained at each of receiving paths, 121, 122, 123, 124, 125, and 126, while the signal has been transmitted from the terminal 110 and received at a single antenna and fed to each of the receiving paths through the divider. The phase error has been measured as shown in FIG. 3A using an array antenna system consisting of 6 antenna elements. As the signal path 121 is arbitrarily selected as a reference one, the relative phase delay along the other signal paths 122-126 can be established as shown in FIG. 4 and Tables 1-4. Table 1 shows an average values of said phase errors in radian measured at the 5 antenna paths, {φᵢ for i=2, 3, . . . , 5}, which represent the phase delay differences relatively to the phase delay associated with 121, φ₁. Table 2 shows the standard deviations of said phase errors measured at the 5 antenna channels. Table 3 shows variations of said phase errors which have been obtained by subtracting the average phase errors from the maximum phase errors. Similarly, Table 4 shows variations of said phase errors which have been obtained by subtracting the minimum phase errors from the average phase errors.

TABLE 1

| mean(φ₁) | mean(φ₂) | mean(φ₃) | mean(φ₄) | mean(φ₅) | mean(φ₆) |
|---|---|---|---|---|---|
| 0 | 1.7710 | 3.3234 | 0.4026 | 0.9678 | 4.5984 |

TABLE 2

| std(φ₁) | std(φ₂) | std(φ₃) | std(φ₄) | std(φ₅) | std(φ₆) |
|---|---|---|---|---|---|
| 0 | 0.0716 | 0.1157 | 0.1021 | 0.1473 | 0.0958 |

TABLE 3

| max(φ₁) | max(φ₂) | max(φ₃) | max(φ₄) | max(φ₅) | max(φ₆) |
|---|---|---|---|---|---|
| — | — | — | — | — | — |

| mean(φ₁) | mean(φ₂) | mean(φ₃) | mean(φ₄) | mean(φ₅) | mean(φ₆) |
|---|---|---|---|---|---|
| 0 | 0.1556 | 0.2911 | 0.2752 | 0.4101 | 0.3006 |

TABLE 4

| mean(φ₁) | mean(φ₂) | mean(φ₃) | mean(φ₄) | mean(φ₅) | mean(φ₆) |
|---|---|---|---|---|---|
| — | — | — | — | — | — |

| min(φ₁) | min(φ₂) | min(φ₃) | min(φ₄) | min(φ₅) | min(φ₆) |
|---|---|---|---|---|---|
| 0 | 0.1939 | 0.3678 | 0.3092 | 0.4213 | 0.2670 |

From Tables 1-4, it can surely be observed that, when a signal is received from a terminal 110, the phase values observed at each of antenna channels are not equal to one another because the phase characteristics along the signal path corresponding to each of antenna channels are all different. The differences or irregularities at each of antenna channels, which cause the phase characteristics at each of antenna channels become all different, should be compensated through calibration.

FIG. 4 illustrates the phase characteristics of an array antenna system consisting of 6 antenna elements. Letting the phase characteristic of one antenna channel, 121, which has been arbitrarily selected, be zero, the phase characteristics of the other 5 antenna channels, 122, 123, 124, 125, and 126, are found to be all different as shown in FIG. 4. In FIG. 4, “A”-“E” denote the phase error at the signal paths 122-126, respectively, when the phase delay associated with the signal path 121 is assumed to be zero. It can also be observed that the phase error at each of signal paths along the corresponding antenna elements remains near its average value as time passes by, although the phase delay at each of antena channels itself is different from one another. From the analysis discussed above, it can be observed that the phase differences or irregularities at each of signal paths associated with the corresponding antenna elements in array antenna system can be compensated through a proper calibration procedure in which the compensating phase value is obtained by reflecting the pre-computed value of phase delay between said additional antenna and each of antenna elements of the array system.

The key part of this invention is that the phase delay between said additional antenna element and each of antenna elements in a given array antenna system is computed in advance such that the pre-computed phase delay is reflected in the calibration procedure for the phase characteristic at each of antenna channels to be effectively compensated. Detailed application examples are shown in the following part of this invention.

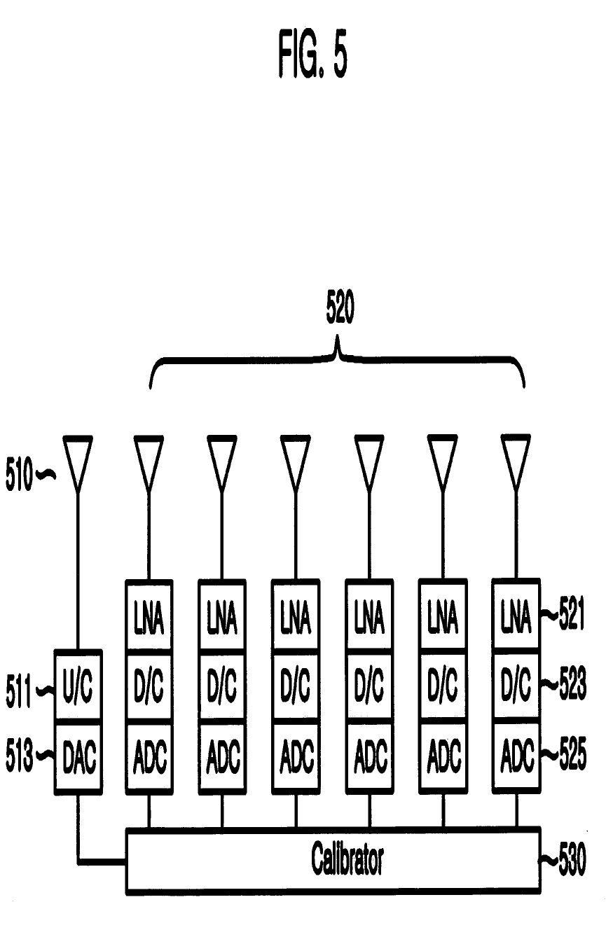

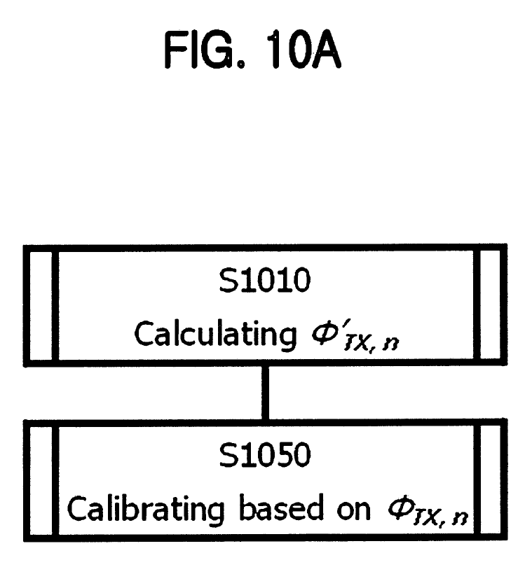

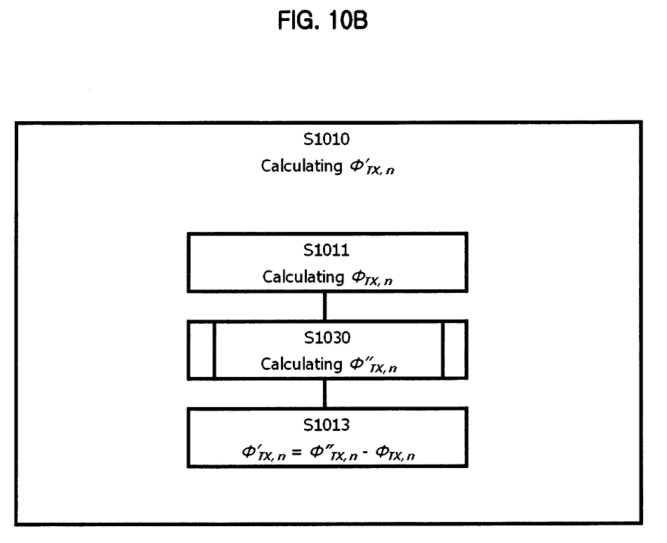

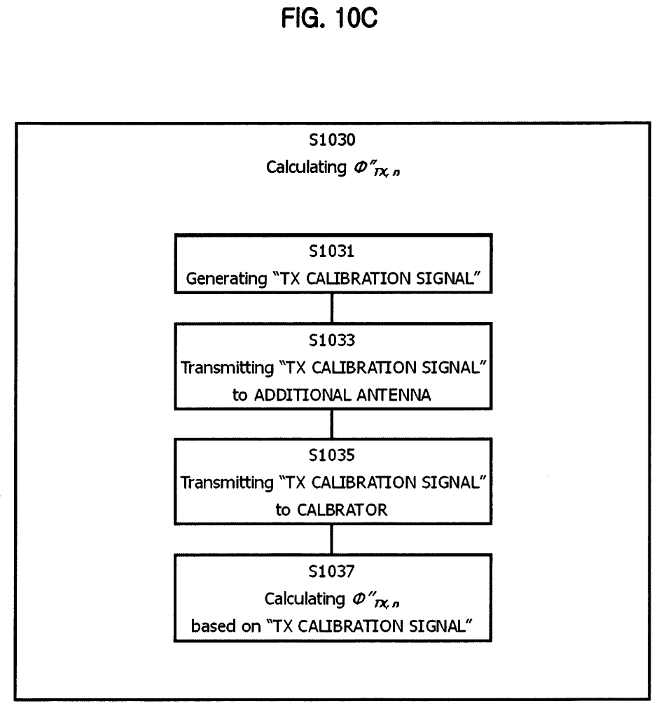

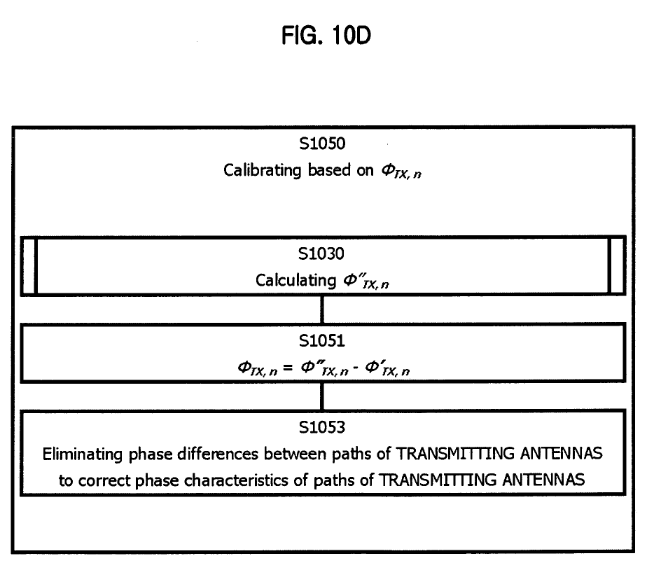

FIG. 5 and FIG. 10 illustrate block diagrams of array antenna system designed in accordance with the first application example of this invention.

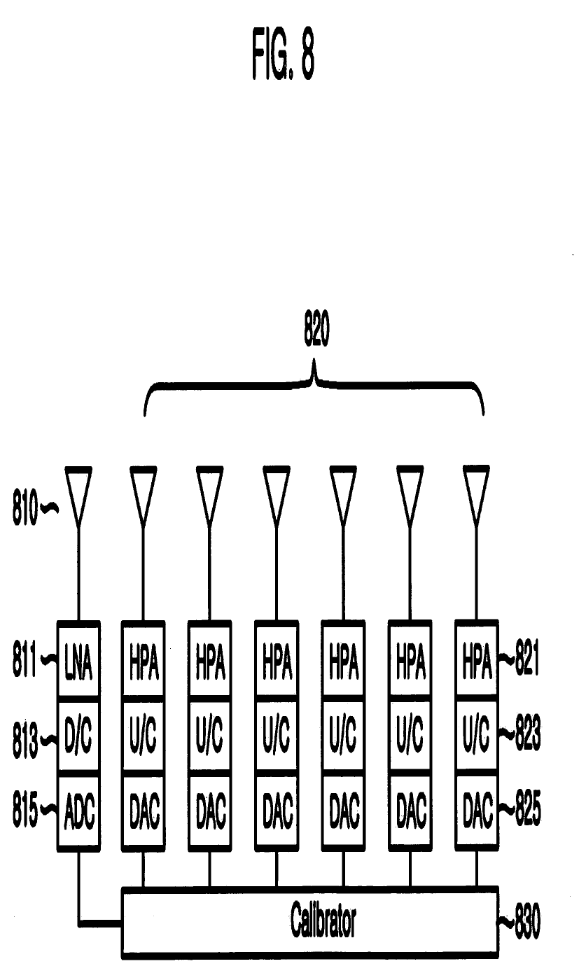

FIG. 5 is a block disgram of calibration apparatus of receiving array antenna system design in accordance with the first application example of this invention. According to the first application example of this invention, as the phase delay between said additional antenna element 510 and each of receiving antenna elements 520 is computed in advance of the calibration procedure, there is no restriction at all on the location of said additional antenna 510 or topology of array antenna element 520. In the meantime, the receiving antenna elements 520 do not have to be prepared separately from transmitting antenna elements (shown as transmitting antenna 820 in FIG. 8) in array antenna system. It means a single antenna element can be used for both receiving and transmitting mode. Duplexer or switch can be used to distinguish the receiving and transmitting function from each other. Duplexer is used for FDD (frequency dividion duplexing) system and switch is used for TDD (time division duplexing) system.

As shown in FIG. 5, calibration apparatus according to the first application example of this invention consists of additional antenna element 510 and frequency up-converter (U/C) 511 and digital-to-analog converter (DAC) that are connected to the additional antenna 510, plural receiving antenna elements 520 with arbitrary spacing and topology, low noise amplifiers (LNA) 521, frequency down-converters (D/C) 523, analog-to-digital converters (ADC) 525, and claribrator 530. Note that each of LNA's 521, D/C's 523, and ADC's 525 is connected to each of receiving antenna elements 520, correspondingly.

Calibration procedure performed in the calibration apparatus shown in FIG. 5 can be summarized as follows. Said additional antenna element 510 transmits a signal that is generated in said calibrator 530 and provided through said DAC 513 and U/C 511. The signal transmitted from said additional antenna element 510 will be denoted in this invention as “Rx calibration signal” from now on. Said Rx calibration signal generated in base-band at said calibrator 530 is first modulated into its analog form in said DAC 513 and then the frequency range of said analog-converted Rx calibration signal is converted to the receiving carrier frequency band of said array antenna system in said U/C 511. It is recommanded not to use high power amplifier (HPA) when said Rx calibration signal is transmitted from said additional antenna element 510 in order to reduce interference due to the Rx calibration signal itself. Each of said receiving antenna elements 520 receives said Rx calibration signal which is transmitted from said additional antenna element 510, and the received Rx calibration signal is tranferred to said calbrator 530 by way of said LNA 521, D/C 523, and ADC 525. Said LNA 521 amplifies the received Rx calibration signal with a minimum noise, D/C 523 converts the frequency range of the received Rx calibration signal into base-band, and ADC 525 converts the Rx calibration signal into digital data.

In the meantime, said Rx calibration signal should be distinguished from the other signals used for normal communication purposes because the calibration can be performed while the array antenna system is operating. In order for said Rx calibration signal to be distinguished from the other communication signals used by the subscribers communicating with the array antenna system, it is recommanded that said “Rx calibration signal” is orthogonal or quasi-orthogonal to the other signals such that said “Rx calibration signal” can be separated from the other signals at the calibrator 530.

Based on the phase delay of the “Rx calibration signal” obtained from said ADC 525, said calibrator 530 measures the differences of phase delays at each of signal paths associated with each of receiving antenna elements 520 such that the phase delays associated with each of antenna elements 520 can be resolved as a result of calibration procedure. Said calibrator 530 computes the differences of the phase delays associated with each of the antenna elements 520 using “Rx calibration signal” received from each of the receiving antenna elements 520. It is important that the phase delay between additional antenna 510 and each of antenna elements 520 that are obtained in advance of the calibration procedure should appropriately be taken into consideration in computing the phase differences.

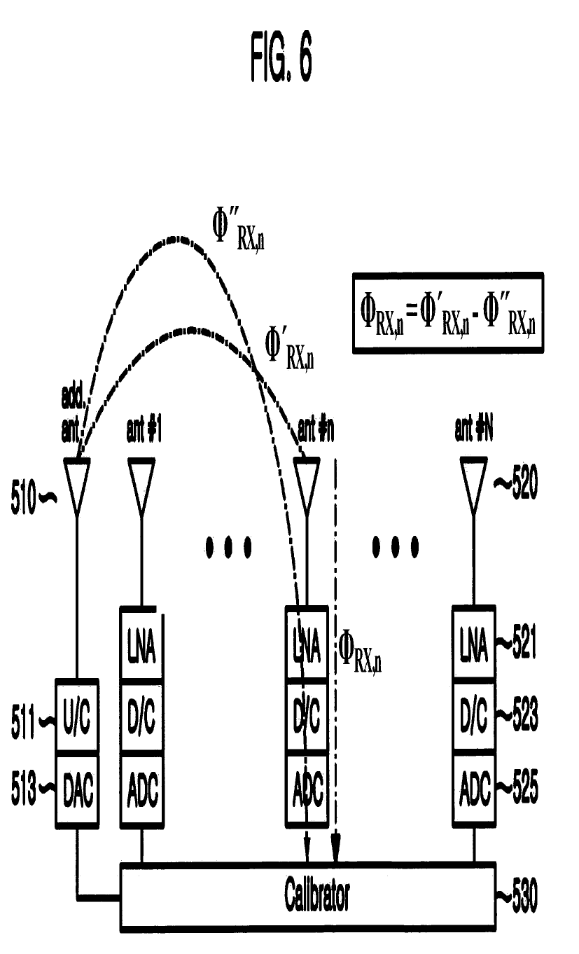

FIG. 6 shows a block diagram of calibration apparatus according to the first application example, which can be applied to calibration apparatus shown in FIG. 5. FIG. 6 shows how the phase delay between the additional antenna element and each of receiving antenna elements is computed during the calibartion period. The phase delay at each of signal paths is defined as follows:
φ′_{RX, n} Phase delay between the additional antenna element 510 and the n_th receivng antenna 520 for n=1, 2, . . . , N where N is the total number of receiving antenna elements in the array antenna system. Note that φ′_{RX, n} for n=1, 2, . . . , N is measured in advance of the calibration procedure. It can even be measured in advance of the normal operation of the array antenna system.
φ″_{RX, n} Phase delay between the additional antenna element 510 and calibrator 530. Note that the phase delay φ″_{RX, n} is associated with the following signal path: additional antenna 510→n_th receiving antenna 520→n_th LNA 521→n_th D/C 523→n_th ADC 525→ calibrator 530.
φ_{RX, n} Phase delay between the n_th receiving antenna element 520 and calibrator 530. Note that the phase delay φ_{RX, n} is associated with the following signal path: n_th receiving antenna 520→n_th LNA 521→n_th D/C 523→n_th ADC 525→ calibrator 530.

From the discussions given above, it can be found that the phase delay that has to be compensated for calibrating the signal path associated with each of receiving antenna elements 520 is
φ_{RX, n}=φ″_{RX, n}−φ′_{RX, n}
for n=1, 2, . . . , N where N is the number of said receiving antenna elements in the array antenna system.

According to the first application example of this invention, in advance of the calibration procedure for the array antenna system, the phase delay (φ′_{RX, n}) between the additional antenna element 510 and each of plural receiving antenna elements 520 should be obtained. It particularly means that φ′_{RX, n} should be obtained for all n. In order to obtain the phase delay (φ′_{RX, n}) between the additional antenna element 510 and each of plural receiving antenna elements 520, the phase delay (φ_{RX, n}) between each of receiving antenna elements 520 and the calibrator 530 and the phase delay (φ″_{RX, n}) between the additional antenna element 510 and the calibrator 530 are computed in advance. After computing the phase delays φ_{RX, n} and φ″_{RX, n}, the phase delay φ′_{RX, n} is obtained by φ′_{RX, n}=φ″_{RX, n}−φ_{RX, n}. Note that the phase delay φ′_{RX, n} between the additional antenna element 510 and each of receiving antenna elements 520 is computed in advance of normal operation of array antenna system only once at the initial stage, for example, when the array antenna system is first installed. This phase delay φ′_{RX, n} is then used whenever the calibration is performed in the array antenna system.

The calibration disclosed in this invention is based upon the the phase delay φ′_{RX, n} between the additional antenn element 510 and each of receiving antenna elements 520 More specifically, the calibrator 530 produces the phase delay φ″_{RX, n} between the additional antenna element 510 and the calibrator 530 from the “Rx calibration signal” received at each of N receiving antenna elements 520. The phase delay φ_{RX, n} to be compensated at each of signal paths associated with N receiving antenna elements 520 is obtained by subtracting the pre-computed phase delay φ′_{RX, n} between the additional antenna element 510 and each of N receiving antenna elements 520 from the phase delay φ″_{RX, n} between the additional antenna element 510 and the calibrator 530 The computation of the phase delay φ′_{RX, n} is performed for all N receiving antenna elements 520, i.e., for n=1, 2, . . . , N, thus {φ_{RX, 1}, . . . , φ_{RX, n}, . . . , φ_{RX, N}} are obtained as a result of the calibration procedure. The calibrator 530 produces the phase delay compensation {φ_{RX, 1}, . . . , φ_{RX, n}, . . . , φ_{RX, N}} to resolve the differences or irregularities of the phase delays at the signal paths associated with N receiving antenna elements 520.

The calibration procedure of which the major part is to compute the differences or irregularities of phase characteristic at each of signal paths associated with each of N receiving antenna elements 520 can be performed without any restriction on the array structure or antenna topology or location of additional antenna by utiling the phase delay (φ′RX, n) between the additional antenna 510 and each of N receiving antenna elements 520, which is obtained in advance of the calibration procedure.

Furthermore, as the “Rx calibration signal” is distinguishable from the other signals being used by the subscribers, the calibration procedure disclosed in this invention can be performed while the array antenna system is operating for its original purpose.

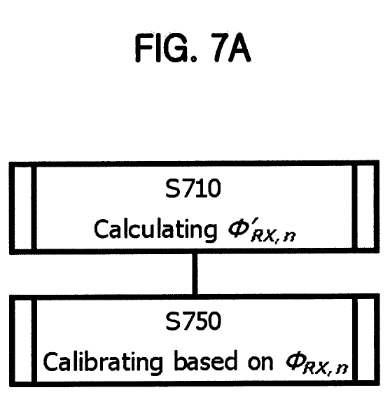

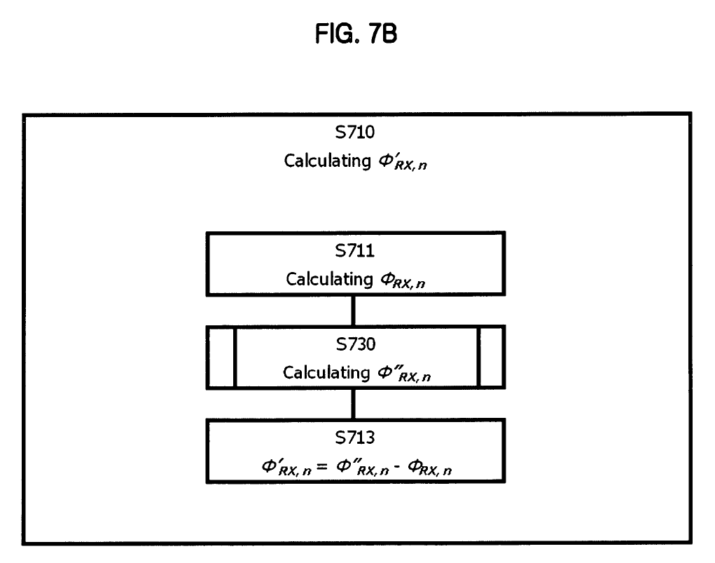

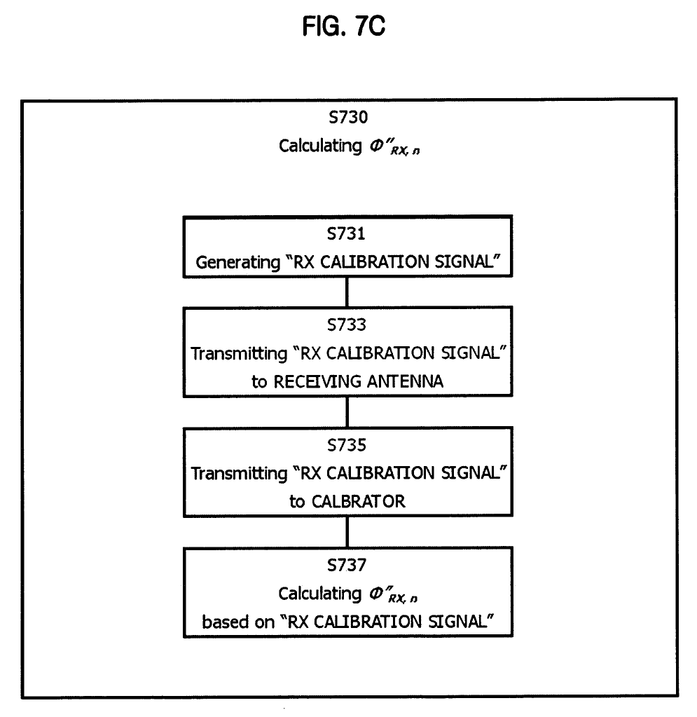

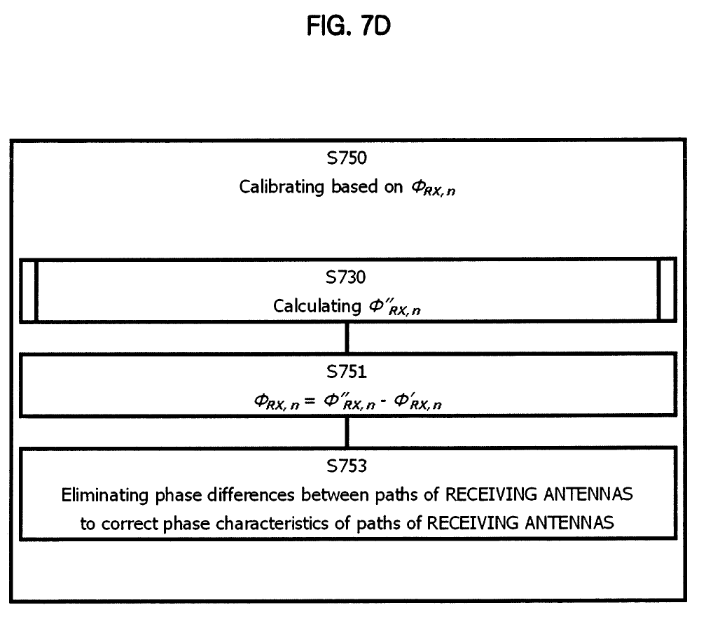

FIG. 7A-7D represent receiving calibration procedure used in calibration apparatus of the array antenna system in accordance with the first application example of this invention. As an example, the calibration procedure shown in FIGS. 7A-7D are applied to the calibration apparatus shown in FIG. 5.

As shown in FIG. 7A, the calibration according to the first application example consists mainly of two steps, i.e., a step S710 of computing the phase delay (φ′_{RX, n}) between the additional antenna 510 and each of receiving antenna elements 520 in advance of the calibration procedure and the other step S750 of performing the calibration with the phase delay (φ_{RX, n}) between each the receiving antenna elements 520 and the calibrator 530.

As mentioned earlier, it is normal that the step S710 is performed just one time after the structure of the additional antenna 510 and that of plural receiving antenna elements 520 are determined. Note, however, that the phase delay (φ′_{RX, n}) which is obtained in the step S710 is needed whenever the calibration step S750 is performed. Meanwhile, the calibration procedure of step S750 can be executed repeatedly or periodically depending upon the signal environment where the array antenna system is operating.

As shown in FIG. 7B, the phase delay (φ_{RX, n}) between each of N receiving antenna elements 520 and the corresponding port of the calibrator 530 and the phase delay ((φ″_{RX, n}) between the additional antenna 510 and the calibrator 530 are obtained in S711 and S730 respectively, in the step S710 of computing the phase delay(φ′_{RX, n}). The order of performing steps S711 and S730 does not cause any difference in the calibration performance. The difference between the phase delay φ″_{RX, n} and φ_{RX, n}, i.e., (φ″_{RX, n}−φ_{RX, n}), each of which is obtained in S711 and S730 respectively, produces the phase delay (φ′_{RX, n}) between the additional antenna element 510 and each of N receiving antenna elements 520. The step of computing the phase delay (φ′_{RX, n}) between the additional antenna element 510 and each of N receiving antenna elements 520 from the difference between φ″_{RX, n} and φ_{RX, n} will be denoted as step S713.

The phase delay (φ_{RX, n}) is obtained in S711 after the differences in all the φ′_{RX, nS} as are removed such that it becomes φ′_{RX, n}=φ′_{RX,m} for all 0≦n≦N and 0≦m≦N. FIG. 3A shows one way of removing the differences among the phase delays {φ′_{RX, n} for n=1, 2, . . . , N} utilizing a divider. It particularly means that the phase delay between the additional antenna 510 and each of receiving antenna elements 520 becomes all the same, i.e., φ′_{RX, n}=φ′_{RX,m} for all 0≦n≦N and 0≦m≦N, if the “Rx calibration signal” is received at a single common receiving antenna element and fed to each of receiving signal paths through the divider as shown in FIG. 3A. Then, the relative differences among the phase delay φ″_{RX, n}, which is obtained in S730 of which the details are described below, can be used as the phase delay compensation of the calibration.

As shown in FIG. 7C, the step S730 of computing the phase delay (φ″_{RX, n}) starts from the step S731 in which the calibrator 530 genrates “Rx calibration signal”. As mentioned earlier, said “Rx calibration signal” is distinguishable from the other signals used for normal communication purpose during the operation of array antenna system. The additional antenna 510 transmits the “Rx calibration signal” that is provided by the calibrator 530 in step S731 through the DAC 513 and U/C 511. The step of transmitting the “Rx calibration signal” from the additional antenna to the plural receiving antenna elements will be denoted as step S733. In the U/C 511 the frequency of “Rx calibration signal” that has been modulated into an analog signal is up-converted into the receiving RF (radio frequency) band of the receiving array antenna system. Each of the plural receiving antenna elements 520 receives the “Rx calibration signal” that has been transmitted during the step of S733 and sends the received “Rx calibaration signal” to the calibrator 530 by way of the LNA 521, D/C 523, and ADC 525. The step of passing the “Rx calibration signal” from each of receiving antenna elements 520 to the corresponding port of the calibrator 530 will be denoted as step S735 The calibrator 530 produces the phase delay (φ″_{RX, n}) between the additional antenna and the calibrator 530 from the “Rx calibration signal” received through the step S735 The step of producing the phase delay (φ″_{RX, n}) between the additional antenna and the calibrator 530 will be denoted as step S737.

Once the phase delay (φ′_{RX, n}) between the additional antenna and each of receiving antenna elements 520 is obtained as shown in S710 in advance of the calibration prcedure, the calibration procedure is performed as shown in FIG. 7D for computing the phase compensation value (φ_{RX, n}). Note that, as mentioned earlier, the computation of the phase delay (φ′_{RX, n}) between the additional antenna and each of receiving antenna elements 520 is performed only once while the calibration procedure for computing the phase compensation value (φ_{RX, n}) is performed repeatedly or periodically according to the need of calibration. As shown in FIG. 7D, the calibration procedure of step S750 for computing the phase delay (φ_{RX, n}) between each of the receiving antenna elements 520 and the corresponding port of the calibrator 530 starts from the step S730 in which the phase delay (φ″_{RX, n}) is generated. The step S750 also includes a substep S730 for measuring the phase delay (φ″_{RX, n}) between the additional antenna 510 and each of corresponding ports of the calibrator 530 as in step S710. The difference between S730 in S750 and that in S710 can be summarized as follows.

In S730 of S710 the “Rx calibration signal” is received at a single antenna in order to equalize all the phase delays (φ′_{RX, n}) associated with each of receiving antenna elements 520 and the received “Rx calibration signal” is provided to each of antenna channels by way of the divider as shown in FIG. 3A for measuring the phase delay (φ″_{RX, n}) at each of corresponding ports of the calibrator 530, whereas the “Rx calibration signal” is received at each of receiving antenna elements 520 in S730 of S750 and fed to each of antenna channels for measuring the phase delay (φ″_{RX, n}) at each of corresponding ports of the calibrator 530.

The phase delay (φ′_{RX, n}) is obtained from the step S710 whereas the phase delay (φ″_{RX, n}) is obtained from the step S730. From these two sets of phase delays (φ′_{RX, n}) and (φ″_{RX, n}), the calibrator 530 produces the phase compensation (φ_{RX, n}) by (φ_{RX, n}=φ″_{RX, n}−φ′_{RX, n}). The step of producing the phase compensation (φ_{RX, n}) will be denoted as step S751. Note that the phase compensation in the early part of this invention was referred to as “phase error” . As the phase characteristics at each of antenna channels can vary from time to time, the phase compensation (φ_{RX, n}) need to be computed repeatedly or periodically according to the need of given signal environment. The calibrator 530 produces the phase compensation values {φ_{RX, 1}, . . . , φ_{RX, n}, . . . , φ_{RX, N}} for each of receiving antenna channels through the step S751. Based on the phase compensation values {φ_{RX, 1}, . . . , φ_{RX, n}, . . . , φ_{RX, N}}, the calibrator 530 compensates the differences or irregularities, which was referred to as “phase error” in the preceding parts of this invention, at each of signal paths associated with each of receiving antenna elements 520. This compensating procedure is referred to as step S753. The calibration procedure for the receiving mode is completed as the step S753 is performed.

Summarizing the discussions above, the first application example of the present invention makes it possible that the calibration be performed while the array antenna system is operating without any restriction on the structure of the array antenna element, the location of the additional antenna, topology of each antenna element, etc. The above merits are indeed provided by the present invention because of the following two main reasons: firstly, the “Rx calibration signal” is distinguishable from the other signals that are used by the subscribers, secondly, the phase delay (φ′_{RX, n}) between the additional antenna element and each of receiving antenna elements is measured in advance of the calibration procedure as shown in step S710 and reflected properly in computing the phase compensation value as shown in step S750.

FIG. 8 illustrates a block diagram of calibration apparatus of transmitting array antenna system designed in accordnace with the first application example of the present invention. According to the first application example of the present invention, as the phase delay between the additional antenna element 810 and each of transmitting antenna elements 820 is computed in advance of the trasnmitting calibration procedure and reflected properly duirng the transmitting calibration procedure, the transmitting calibration technology disclosed in the present invention does not have any restrictions on the location of the additional antenna element or structure of the transmitting array antenna element or topology of each antenna element, etc. In the meantime, the transmitting antenna elements 820 do not always have to be prepared separately from the receiving antenna elements (shown as the receiving antenna elements 520 in FIG. 5) in the array antenna system. It particularly means that a single antenna element can be shared for both receiving and transmitting purposes. In this case, duplexer or switch can be used to distinguish the receiving and transmitting function from each other. Duplexer is used for FDD (frequency dividion duplexing) system and switch is used for TDD (time division duplexing) system.

As shown in FIG. 8, calibration apparatus according to the first application example of this invention consists of additional antenna element 810 and low noise amplifier (LNA) 811, frequency down-converter (U/C) 813 and analog-to-digital converter (ADC) 815 that are connected to the additional antenna 810, plural transmitting antenna elements 820 with arbitrary spacing and topology, high power amplifier (HPA) 821, frequency up-converters (U/C) 823, digital-to-analog converters (DAC) 825, and calibrator 830. Note that each of HPA's 821, U/C's 823, and DAC's 825 is connected to each of transmitting antenna elements 820, correspondingly.

Calibration procedure performed in the calibration apparatus shown in FIG. 8 can be summarized as follows. The plural transmitting antenna elements 820 transmit a signal that is generated in said calibrator 830 and provided through said DAC 825 and U/C 823. The signal transmitted from said plural transmitting antenna elements 820 will be denoted in this invention as “Tx calibration signal” from now on. Said Tx calibration signal generated in base-band at said calibrator 830 is first modulated into its analog form in said DAC 825 and then the frequency range of said analog-converted Tx calibration signal is converted to the transmitting carrier frequency band of said array antenna system in said U/C 823.

The aditional antenna element 810 receives said Tx calibration signal which is transmitted from said plural transmitting antenna elements 820, and the received Tx calibration signal is tranferred to said calbrator 830 by way of said LNA 811, D/C 813, and ADC 815. Said LNA 811 amplifies the received Tx calibration signal with a minimum noise, D/C 813 converts the frequency range of the received Tx calibration signal into base-band, and ADC 815 converts the Tx calibration signal into digital data.

As the calibration may be executed during the normal operation of the array antenna system, “Tx calibration signal” must be distinguishable from the other signals used by subscribers. In order for said Tx calibration signal to be distinguished from the other communication signals used by the subscribers communicating with the array antenna system, it is recommanded that said “Tx calibration signal” is orthogonal or quasi-orthogonal to the other signals such that said “Tx calibration signal” can be separated from the other signals at the calibrator 830.

Furthermore, “Tx calibration signal” transmitted from each of the transmitting antenna elements 820 of the array antenna system should also be distinguishable from one another when all the transmitting antenna elements 820 transmits the “Tx calibration signal” at the same time. However, when the “Tx calibration signal” is transmitted at each of the transmitting antenna elements 820 sequencially, i.e., when only one transmitting antenna element transmits the Tx calibration signal at a time, then a single “Tx calibration signal” can be used in common at all the transmitting antenna elements 820.

The calibrator 830 compensates for the phase differences in the signal paths associated with each of the transmitting antenna elements 820 utilizing the “Tx calibration signal” provided through the ADC 815. The calibrator 830 explicitly computes the differences of the phase characteristics of each of signal paths associated with each of transmitting antenna elements 820 utilizing the “Tx calibration signal” that has been received through the signal path associated with each of transmitting antenna elements 820. In computing the phase differences at each of transmitting antenna channels, the phase delay between the additional antenna 810 and each of transmitting antenn elements 820, which has been obtained apriori to the calibration procedure, should appropriately be encountered.

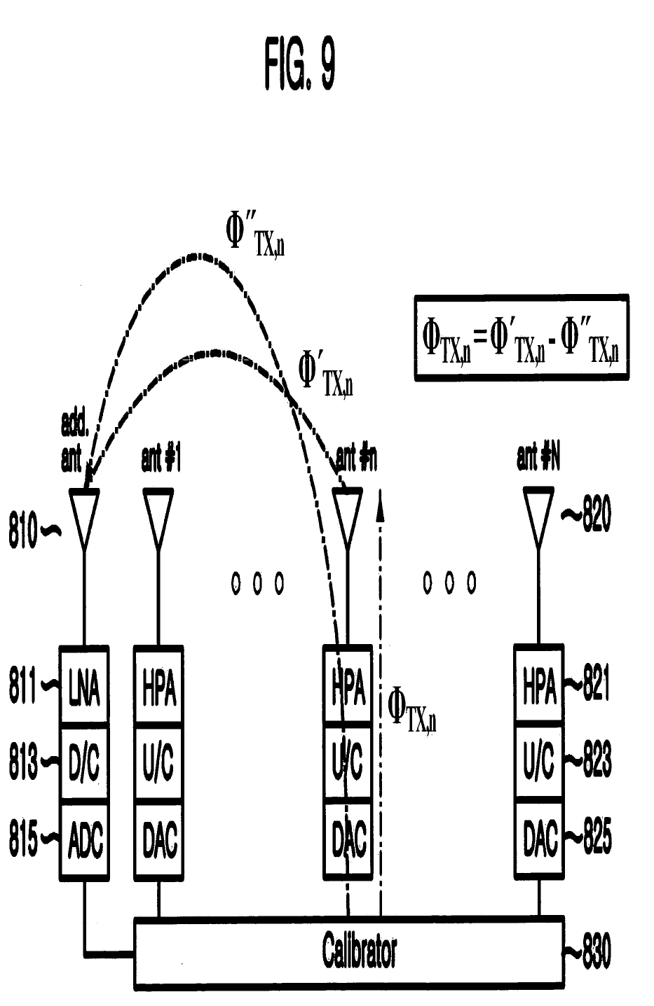

FIG. 9 shows a block diagram of calibration apparatus according to the first application example, which can be applied to calibration apparatus shown in FIG. 8. FIG. 9 shows how the phase delay between the additional antenna element and each of the transmitting antenna elements is computed during the calibartion period. The phase delay at each of signal paths is defined as follows:
φ′_{TX, n} Phase delay between the additional antenna element 810 and the n_th transmitting antenna 820 for n=1, 2, . . . , N where N is the total number of transmitting antenna elements in the array antenna system. Note that φ′_{TX, n} for n=1, 2, . . . , N is measured in advance of the calibration procedure. It can even be measured in advance of the normal operation of the array antenna system.
φ″_{TX, n} Phase delay between the calibrator 830 and additional antenna element 810. Note that the phase delay φ″_{TX, n} is associated with the following signal path: calibrator 830→DAC 825→U/C 823→HPA 821→n_th transmitting antenna 820→ additional antenna 810.
φ_{TX, n} Phase delay between the calibrator 830 and n_th transmitting antenna element 820. Note that the phase delay φ_{TX, n} is associated with the following signal path: calibrator 830→DAC 825→U/C 823→HPA 821→n_th transmitting antenna 820.

From the discussions given above, it can be found that the phase delay that has to be compensated for calibrating the signal path associated with each of transmitting antenna elements 820 is
φ_{TX, n}=φ″_{TX, n}−φ″_{TX, n}
for n=1, 2, . . . , N where N is the number of said transmitting antenna elements in the array antenna system.

According to the first application example of this invention, in advance of the calibration procedure for the transmitting array antenna system, the phase delay (φ′_{TX, n}) between the additional antenna element 810 and each of plural transmitting antenna elements 820 should be obtained. It particularly means that φ′_{TX, n} should be obtained for all n. In order to obtain the phase delay (φ′_{TX, n}) between the additional antenna element 810 and each of plural transmitting antenna elements 820, the phase delay (φ_{TX, n}) between the calibrator 830 and each of transmitting antenna elements 820 and the phase delay (φ″_{TX, n}) between the calibrator 830 and the additional antenna element 810 are computed in advance. After computing the phase delays φ_{TX, n} and φ″_{TX, n}, the phase delay φ′_{TX, n} between each of the transmitting antenna elements 820 and the additional antenna 810 is obtained by φ″_{TX, n}=φ″_{TX, n}−φ_{TX, n}. Note that the phase delay φ′_{TX, n} between each of the transmitting antenna elements 820 and the additional antenna 810 is computed in advance of normal operation of array antenna system only once at the initial stage, for example, when the array antenna system is first installed. This phase delay φ′_{TX, n} is then used whenever the calibration is performed in the array antenna system.

The calibration disclosed in this invention is based upon the phase delay φ′_{TX, n} between each of the transmitting antenna elements 820 and the additional antenna 810. More specifically, the calibrator 830 produces the phase delay φ″_{TX, n} between the calibrator 830 and the additional antenna element 810 from the “Tx calibration signal” that is transmitted from each of transmitting antenna elements 820 and received at the additional antenna element 810. The phase delay φ_{TX, n} to be compensated at each of signal paths associated with N transmitting antenna elements 820 is obtained by subtracting the pre-computed phase delay φ′_{TX, n} between each of N transmitting antenna elements 820 and the additional antenna element 810 from the phase delay φ″_{TX, n} between the calibrator 830 and the additional antenna element 810. The computation of the phase delay φ′_{TX, n} is performed for all N transmitting antenna elements 820, thus {φ_{TX, 1}, . . . , φ_{TX, n}, . . . , φ_{TX, N}} are obtained as a result of the calibration procedure. The calibrator 830 produces the phase delay compensation {φ_{TX, 1}, . . . , φ_{TX, n}, . . . , φ_{TX, N}} to resolve the differences or irregularities of the phase delays at the signal paths associated with N transmitting antenna elements 820.

The calibration procedure of which the major part is to compute the differences or irregularities of phase characteristic at each of signal paths associated with each of N transmitting antenna elements 820 can be performed without any restriction on the array structure or antenna topology or location of additional antenna by utiling the phase delay (φ′_{TX, n}) between each of N transmitting antenna elements 820 and the additional antenna 810, which is obtained in advance of the calibration procedure.

Furthermore, as the “Tx calibration signal” is distinguishable from the other signals being used by the subscribers, the calibration procedure disclosed in this invention can be performed while the array antenna system is operating for its original purpose.

FIG. 10A-10D represent transmitting calibration procedure used in calibration apparatus of the array antenna system in accordance with the first application example of this invention. As an example, the calibration procedure shown in FIGS. 10A-10D are applied to the calibration apparatus shown in FIG. 8.

As shown in FIG. 10A, the calibration according to the first application example consists mainly of two steps, i.e., a step S1010 of computing the phase delay (φ′_{TX, n}) between each of transmitting antenna elements 820 and the additional antenna 810 in advance of the calibration procedure and the other step S1050 of performing the calibration with the phase delay (φ_{TX, n}) between the calibrator 830 and each the transmitting antenna elements 820.

As mentioned earlier, it is normal that the step S1010 is performed just one time after the structure of the additional antenna 810 and that of plural transmitting antenna elements 820 are determined. Note, however, that the phase delay (φ′_{TX, n}) which is obtained in the step S1010 is needed whenever the calibration step S1050 is performed. Meanwhile, the calibration procedure of step S1050 can be executed repeatedly or periodically depending upon the signal environment where the array antenna system is operating.

As shown in FIG. 10B, the phase delay (φ_{TX, n}) between the corresponding port of the calibrator 830 and each of N transmitting antenna elements 820 and the phase delay (φ″_{TX, n}) between the calibrator 830 and the additional antenna 810 are obtained in S1011 and S1030, respectively, in the step S1010 of computing the phase delay(φ′_{TX, n}). The order of performing steps S1011 and S1030 does not cause. any difference in the calibration performance. The difference between the phase delay φ″_{TX, n} and φ_{TX, n}, i.e., (φ″_{TX, n}−φ_{TX, n}), each of which is obtained in S1011 and S1030, respectively, produces the phase delay (φ′_{TX, n}) between each of N transmitting. antenna elements 820 and the additional antenna element 810 The step of computing the phase delay (φ′_{TX, n}) between each of N transmitting antenna elements 820 and the additional antenna element 810 from the subtraction of φ_{TX, n} from φ″_{TX, n} will be denoted as step S1013.

The phase delay (φ_{TX, n}) is obtained in S1011 after the differences in all the φ′_{TX, n}s are removed such that it becomes φ′_{TX, n}=φ′_{TX,m} for all 0≦n≦N and 0≦m≦N. FIG. 3B shows one way of removing the differences among the phase delays {φ′_{TX, n} for n=1, 2, . . . , N} utilizing a divider. It particularly means that the phase delay between each of transmitting antenna elements 820 and the additional antenna 810 becomes all the same, i.e., φ′_{TX, n}=φ′_{TX,m} for all 0≦n≦N and 0≦m≦N, if the “Tx calibration signal” is transmitted from a single common transmitting antenna element as shown in FIG. 3B. Then, the relative differences among the phase delay φ″_{TX, n}, which is obtained in S1030 of which the details are described below, can be used as the phase delay compensation of the calibration.

As shown in FIG. 10C, the step S1030 of computing the phase delay (φ″_{TX, n}) starts from the step S1031 in which the calibrator 830 genrates “Tx calibration signal”. As mentioned earlier, said “Tx calibration signal” is distinguishable from the other signals used for normal communication purpose during the operation of array antenna system. Furthermore, “Tx calibration signal” transmitted from each of the transmitting antenna elements 820 of the array antenna system should also be distinguishable from one another when all the transmitting antenna elements 820 transmits the “Tx calibration signal” at the same time. However, when the “Tx calibration signal” is transmitted at each of the transmitting antenna elements 820 sequencially, i.e., when only one transmitting antenna element transmits the Tx calibration signal at a time, then a single “Tx calibration signal” can be used in common at all the transmitting antenna elements 820. Each of transmitting antenna elements 820 transmits the “Tx calibration signal” that is provided by the calibrator 830 in step S1031 through the DAC 825 and U/C 823. The “Tx calibration signal” transmitted from each of transmitting antenna elements 820 is to be received by the additional antenna element 810 The step of transmitting the “Tx calibration signal” from each of transmitting antenna elements 820 to the additional antenna element 810 will be denoted as step S1033 In the U/C 823, the frequency of “Tx calibration signal” that has been modulated into an analog signal at the DAC 825 is up-converted into the transmitting RF (radio frequency) band of the transmitting array antenna system. The additional antenna element 810 receives the “Tx calibration signal” that has been transmitted during the step of S1033 and sends the received “Tx calibaration signal” to the calibrator 830 by way of the LNA 811, D/C 813, and ADC 815. The step of passing the “Tx calibration signal” from the additrional antenna 810 to the corresponding port of the calibrator 830 will be denoted as step S1035. The calibrator 830 produces the phase delay (φ″_{TX, n}) between the calibrator 830 and the additional antenna element 810 from the “Tx calibration signal” received through the step S1035. The step of producing the phase delay (φ″_{TX, n}) between the calibrator 830 and the additional antenna element 810 will be denoted as step S1037.

Once the phase delay (φ′_{TX, n}) between each of N transmitting antenna elements 820 and the additional antenna element 810 is obtained as shown in S1010 of FIG. 10A-10C in advance of the calibration prcedure, the calibration procedure is performed as shown in FIG. 10D for computing the phase compensation value (φ_{TX, n}). Note that, as mentioned earlier, the computation of the phase delay (φ′_{TX, n}) between each of N transmitting antenna elements 820 and the additional antenna element 810 is performed only once while the calibration procedure for computing the phase compensation value (φ_{TX, n}) is performed repeatedly or periodically according to the need of calibration. As shown in FIG. 10D, the calibration procedure of step S1050 for computing the phase delay (φ_{TX, n}) between the corresponding port of the calibrator 830 and each of the transmitting antenna elements 820 starts from the step S1030 in which the phase delay (φ″_{TX, n}) is generated. The step S1050 also includes a substep S1030 for measuring the phase delay (φ″_{TX, n}) between each of corresponding ports of the calibrator 830 and the additional antenna 810 as in step S1010 The difference between S1030 in S1050 and that in S1010 can be summarized as follows.

In S1030 of S1010, the “Tx calibration signal” which is provided from each of antenna channels consisting of DAC's 825, U/C's 823, and HPA's 821 is combined at the combiner as shown in FIG. 3B, is fed to a single antenna in order to equalize all the phase delays (φ′_{TX, n}) between each of transmitting antenna elements 810 and the additional antenna 810 in measuring the phase delay (φ″_{TX, n}) between the corresponding ports of the calibrator 830 and the additional antenna element 810, whereas, in S1030 of S1050, the “Tx calibration signal” is transmitted from each of transmitting antenna elements 820 and received at the additional antenna 810 for measuring the phase delay (φ″_{TX, n}) at the calibrator 830.

The phase delay (φ′_{TX, n}) is obtained from the step S1010 whereas the phase delay (φ″_{TX, n}) is obtained from the step S1030 From these two sets of phase delays (φ′_{TX, n}) and (φ″_{TX, n}), the calibrator 830 produces the phase compensation (φ_{TX, n}) by (φ_{TX, n}=φ″_{TX, n}−φ′_{TX, n}). The step of producing the phase compensation (φ_{TX, n}) will be denoted as step S1051. Note that the phase compensation in the early part of this invention was referred to as “phase error”. As the phase characteristics at each of antenna channels can vary from time to time, the phase compensation (φ_{TX, n}) need to be computed repeatedly or periodically according to the need of given signal environment. The calibrator 830 produces the phase compensation values {φ_{TX, 1}, . . . , φ_{TX, n}, . . . , φ_{TX, N}} for each of transmitting antenna channels through the step S1051. Based on the phase compensation values {φ_{TX, 1}, . . . , φ_{TX, n}, . . . , φ_{TX, N}}, the calibrator 830 compensates the differences or irregularities, which was referred to as “phase error” in the preceding parts of this invention, at each of signal paths associated with each of transmitting antenna elements 820. This compensating procedure is referred to as step S1053. The calibration procedure for the transmitting mode is completed as the step S1053 is performed.

Summarizing the discussions above, the first application example of the present invention makes it possible that the calibration be performed while the array antenna system is operating without any restriction on the structure of the array antenna element, the location of the additional antenna, topology of each antenna element, etc. The above merits are indeed provided by the present invention because of the following two main reasons: firstly, the “Tx calibration signal” is distinguishable from the other signals that are used by the subscribers, secondly, the phase delay (φ′_{TX, n}) between each of transmitting antenna elements 820 and the additional antenna element 810 is measured in advance of the calibration procedure as shown in step S1010 and reflected properly in computing the phase compensation value as shown in step S1050.

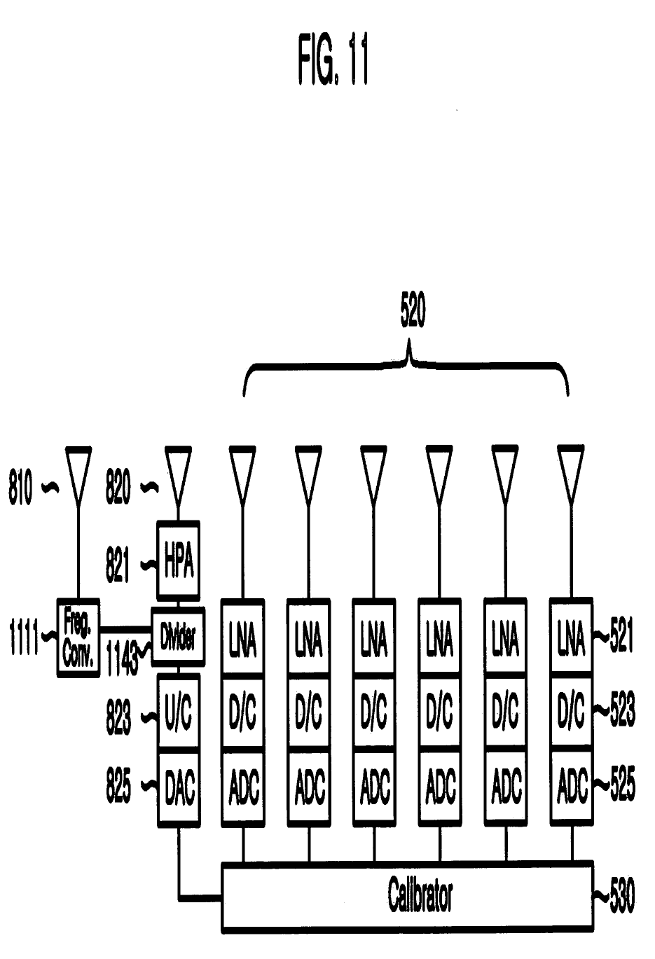

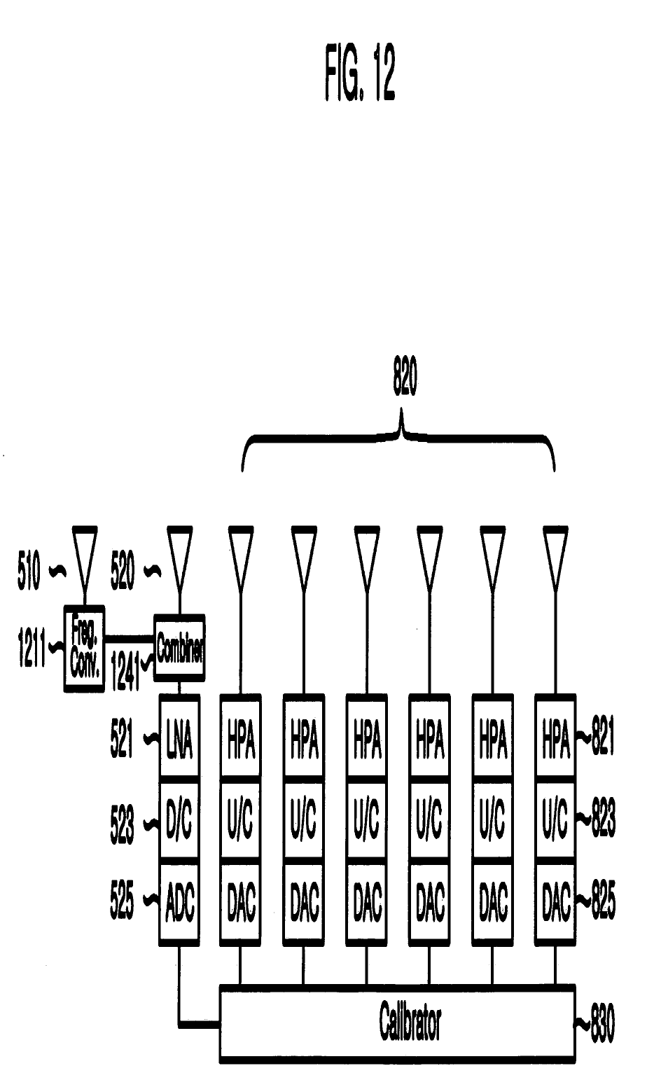

FIG. 11 and FIG. 12 are related to the array antenna system according to the second application example of this invention.

FIG. 11 shows a structure of the calibration apparatus of receiving array antenna system designed in accordance with the second application example of the present invention. The second application example shown in FIG. 11 employs a structure in which the signal path between the DAC 825 and U/C 823 associated with one of the transmitting antenna elements 820 that have been shown in FIG. 8 as the first application example is shared with the additional antenna element 1110 for sending the “Rx calibration signal” generated from the calibrator 530. Consequently, the signal path consisting of DAC 513 and U/C 511, which exist only for the additional antenna 510, is not needed in the second application example. In short, the transmitting signal path associated with one of the transmitting antenna elements 820 is shared with the additional antenna element 1110 for sending the “Rx calibration signal” from the calibrator 530 to the additional antenna element 1110.

In the meantime, the receiving antenna elements 520 does not have to be prepared separately from transmitting antenna elements (shown as transmitting antenna 820 in FIG. 11) in array antenna system. It means a single antenna element can be used for both receiving and transmitting mode. Duplexer or switch can be used to distinguish the receiving and transmitting function from each other. In general, duplexer is used for FDD (frequency dividion duplexing) system while switch is used for TDD (time division duplexing) system.

In FIG. 11, the “Rx calibration signal” generated in the calibrator 530 is sent to frequency converter 1111 by way of the transmitting signal path consisting of DAC 825, U/C 823, and divider 1143. The frequency band of the “Rx calibration signal”, which has arrived at the frequency converter 1111, is the transmitting RF (radio frequency) band of the array antenna system due to the function of U/C 823 as described previously. The frequency converter 1111 converts the freuqency band of the “Rx calibration signal” to the receiving RF band of the array antenna system and transfers it to the additional antenna 810. In the meantime, said “Rx calibration signal” should be distinguished from the other signals used by the subscribers because the calibration can be performed while the array antenna system is operating. In order for said Rx calibration signal to be distinguished from the other communication signals used by the subscribers communicating with the array antenna system, it is recommanded that said “Rx calibration signal” is orthogonal or quasi-orthogonal to the other signals such that said “Rx calibration signal” can be separated from the other signals at the calibrator 530 even when it is received together with the other signals used by the subscribers. The rest parts other than the sharing of the transmitting signal path can be implemented in exactly the same way as in the first application example of the array antenna system which are shown in FIG. 5 or FIG. 7.

FIG. 12 shows a structure of the calibration apparatus of transmitting array antenna system designed in accordance with the second application example of the present invention. The second application example shown in FIG. 12 employs a structure in which the signal path consisting of the LNA 521, D/C 523, and ADC 525 associated with one of the receiving antenna elements 520 that have been shown in FIG. 5 as the first application example is shared with the additional antenna element 510 for receiving the “Tx calibration signal” that has been generated at the calibrator 830 and sent by way of the signal paths of each of transmitting antenna elements 820. Consequently, the signal path consisting of LNA 521, D/C 523, and ADC 525, which exist only for the additional antenna 1210, is not needed in the second application example. In short, the signal path associated with one of the receiving antenna elements 520 is shared with the additional antenna element 510 for transferring the “Tx calibration signal” from the additional antenna element 510 to the calibrator 830.

In the meantime, the transmitting antenna elements 820 does not have to be prepared separately from receiving antenna elements (shown as receivinh antenna 520 in FIG. 12) in array antenna system. It means a single antenna element can be used for both receiving and transmitting mode. Duplexer or switch can be used to distinguish the receiving and transmitting function from each other. In general, duplexer is used for FDD (frequency dividion duplexing) system while switch is used for TDD (time division duplexing) system.

In FIG. 12, the “Tx calibration signal” which is generated at the calibrator 830, is sent to the signal paths consisting of DAC 825, U/C 823, and HPA 821 to be transmitted from each of the transmitting antenna elements 820. The “Tx calibration signal” is then received at the additional antenna element 510.

In the meantime, said “Tx calibration signal” should be distinguished from the other signals used by the subscribers because the calibration can be performed while the array antenna system is operating. In order for the Tx calibration signal to be distinguished from the other communication signals used by the subscribers communicating with the array antenna system, it is recommanded that said “Tx calibration signal” is orthogonal or quasi-orthogonal to the other signals such that said “Tx calibration signal” can be separated from the other signals at the calibrator 830 even when it is received together with the other signals used by the subscribers.

Furthermore, “Tx calibration signal” transmitted from each of the transmitting antenna elements 820 of the array antenna system should also be distinguishable from one another when all the transmitting antenna elements 820 transmits the “Tx calibration signal” at the same time. However, when the “Tx calibration signal” is transmitted at each of the transmitting antenna elements 820 sequencially, i.e., when only one transmitting antenna element transmits the Tx calibration signal at a time, then a single “Tx calibration signal” can be used in common at all the transmitting antenna elements 820.

In FIG. 12, the “Tx calibration signal” that is received at the additional antenna element 510 is sent to frequency converter 1211 The frequency band of the “Tx calibration signal” which has arrived at the frequency converter 1211, is the transmitting RF (radio frequency) band of the array antenna system due to the function of U/C 823 as described previously. The frequency converter 1211 converts the freuqency band of the “Tx calibration signal” to the receiving RF band of the array antenna system and transfers it to the combiner shown in FIG. 12. The rest parts other than the sharing of the receiving signal path can be implemented in exactly the same way as in the first application example of the array antenna system which are shown in FIG. 8 or FIG. 10.

Summarizing the discussions above, the second application example of the present invention makes it possible that the calibration can be performed while the array antenna system is operating without any restriction on the structure of the array antenna element, the location of the additional antenna, topology of each antenna element, etc. The above merits are indeed provided by the present invention because of the following two main reasons: firstly, both “Rx calibration signal” and “Tx calibration signal” are distinguishable from the other signals that are used by the subscribers, secondly, the phase delay (φ′_{RX/TX, n}) between the additional antenna element and each of receiving and transmitting antenna elements is measured in advance of the calibration procedure as shown in step S710 and S1010 and reflected properly in computing the phase compensation value as shown in step S750 and S1050, respectively.

It is clear and straightforward that the scope of the technologies dosclosed in the present invention is not limited by the above mentioned application examples or figures. It should also be noted that the calibration technologies shown in this invention can easily be transformed, modified, or changed in many different ways within the scope of the present invention by ordinary engineers with normal amount of knowledge in the related fields.

As summarized in this document, the phase error, i.e., differences or irregularities of the phase characteristics at each of antenna channels associated with each of receiving and transmitting antenna elements, can be compensated using the pre-computed phase delay values of the additional antenna element, of which the location can be arbitrary.

Due to the calibration procedure which equalizes the phase characteristics of all the signal paths associated with both receiving and transmitting antenna element, the beamforming parameters such as the weight vector of the array antenna system, especially the adaptive array antenna system, obtained for the receiving mode can be used for the transmitting mode. Ultimately, the system performance of array antenna system is greatly enhanced by the accurate calibration.

What is claimed is:

1. A calibration apparatus of an adaptive array antenna system, the calibration apparatus comprising:
calibrator means that generates the “Rx calibration signal” and performs the calibration procedure based on the “Rx calibration signal” received at each of receiving antenna elements of the array antenna means;
additional antenna means that transmits the “Rx calibration signal” to the receiving antenna elements of the array antenna means with an arbitrary arrangement and spacing in a freuqency band of receiving RF (radio frequency); and
array antenna means with an arbitrary arrangement and spacing of antenna elements that transfers the “Rx calibration signal”, which have been received from the additional antenna means, to the calibrator means,
wherein the calibration procedure is performed by a step of compensating the differences or irregularities in phase characteristics at each of signal paths associated with each of the receiving antenna elements of the array antenna means utilizing φ_{RX, n} (phase delay between each of receiving antenna elements of the array antenna means and each corresponding port of the calibrator means) that is related with the two sets of phase delay values φ″_{RX, n} (phase delay between the additional antenna means and the calibrator means) and φ′_{RX, n} (phase delay between the additional antenna means and each of the receiving antenna elements of the antenna array means) by a mathematical equation
φ_{RX, n}=φ″_{RX, n}−φ′_{RX, n}
where φ′_{RX, n} is obtained in advance of the calibration procedure.

2. The calibration apparatus recited in claim 1, wherein the “Rx calibration signal” can be distinguished by the calibrator means from the other signals that are used by the subscribers during the operation of the array antenna system.

3. The calibration apparatus recited in claim 2, wherein the “Rx calibration signal” is mutually orthogonal to the other signals used by the subscribers during the operation of the array antenna system.

4. The calibration apparatus recited in claim 2, wherein the “Rx calibration signal” is mutually quasi-orthogonal to the other signals used by the subscribers during the operation of the array antenna system.

5. The calibration apparatus recited in claim 1, wherein the additional antenna means receives the “Rx calibration signal” in baseband from the calibrator means and transmits the “Rx calibration signal” in the RF (radio frequency) band of receiving array antenna system to the receiving antenna elements of the array antenna means.

6. The calibration apparatus recited in claim 1, wherein the additional antenna means uses the transmitting signal path that is assigned to one of the transmitting antenna elements of the array antenna means to receive the “Rx calibration signal” from the calibrator means through the divider after the frequency band of the “Rx calibration signal” is converted from baseband to the RF (radio frequency) band of transmitting array antenna system, and wherein the additional antenna means transmits the “Rx calibration signal” to the receiving antenna elements of the array antenna means after the frequency band of the “Rx calibration signal” is converted once more from the transmitting RF to the receiving RF.

7. The calibration apparatus recited in claim 1, wherein each of the plural antenna elements of the array antenna means can be used for both receiving and transmitting purpose, and wherein the array antenna system separates each of the receiving and transmitting signal paths that is associated with each of the antenna elements of the array antenna means from each other using duplexer in FDD (frequency division duplexing) array antenna system.

8. The calibration apparatus recited in claim 1, wherein each of the plural antenna elements of the array antenna means can be used for both receiving and transmitting purpose, and wherein the array antenna system separates each of the receiving and transmitting signal paths that is associated with each of the antenna elements of the array antenna means from each other using switch in TDD (time division duplexing) array antenna system.

9. The calibration apparatus recited in claim 1, wherein the procedure of computing the phase delay φ′_{RX,} n between the additional antenna means and each of receiving antenna elements of the array antenna means is performed in advance of the calibration procedure of compensating the differences or irregularities in phase characteristics at each of signal paths associated with each of the receiving antenna elements of the array antenna means utilizing the phase delay φ_{RX, n} between each of receiving antenna elements of the array antenna means and each corresponding port of the calibrator means.

10. The calibration apparatus recited in claim 1, wherein the procedure of computing the phase delay φ′_{RX, n} includes the steps of:
a) measuring the phase delay φ_{RX, n} from φ_{RX, n}=φ″_{RX, n}−φ′_{RX, n} where φ″_{RX, n} for n=1, 2, . . . , N is obtained under the condition that the differences among {φ′_{RX, 1}, φ′_{RX, 2}, . . . , φ′_{RX, N}} are removed such that {φ′_{RX, 1}, φ′_{RX, 2}, . . . , φ′_{RX, N}} are all equal to one another, i.e., φ′_{RX,n}=φ′_{RX, m} for 1≦n≦N and 1≦m≦N;
b) measuring the phase delay φ″_{RX, n} between the additional antenna means and the calibarator means without the procedure of removing the differences among the phase delays {φ′_{RX, 1}, φ′_{RX, 2}, . . . , φ′_{RX, N}}; and
c) producing the phase delay φ′_{RX, n} from φ_{RX, n} and φ″_{RX, n} obtained in step a) and b), respectively, in accordance with φ′_{RX, n}=φ″_{RX, n}−φ_{RX, n}.

11. The calibration apparatus recited in claim 10, wherein the step a) is performed by connecting the additional antenna means to each of receiving antenna elements of the array antenna means with wires in such a way that the differences among {φ′_{RX, 1}, . . . , φ′_{RX, 2}, . . . , φ′_{RX, N}} are removed.

12. The calibration apparatus recited in claim 10, wherein the step b) includes the steps of:
d) producing the “Rx calibration signal” at the calibrator means;
e)transmitting the “Rx calibration signal” from the additional antenna means to the receving antenna elements of the array antenna means after converting the frequency band of the “Rx calibration signal” to the receiving RF of the array antenna system;
f)feeding the “Rx calibration signal” to the calibrator means by way of the signal paths of each of the receiving antenna elements of the array antenna means, and
g)measuring the phase delay φ″_{RX, n} at the calibrator means from the “Rx calibration signal” obtained in step f).

13. The calibration apparatus recited in claim 1, wherein the calibration procedure of generating the phase compensation φ_{RX, n} (that is the relative phase delay between each of the receiving antenna elements of the array antenna means and the corresponding port of the calibrator means) includes the steps of:
h) generating the “Rx calibration signal” at the calibrator means;
i) transmitting the “Rx calibration signal”, generated in step h), at the additional antenna means to the receving antenna elements of the array antenna means after converting the frequency band of the “Rx calibration signal” from baseband to the receiving RF band of the array antenna system;
j) feeding the “Rx calibration signal” from each of the receivng antenna elements of the array antenna means to the corresponding port of the calibrator means;
k) measuring the phase delay φ″_{RX, n} from the “Rx calibration signal” obtained in step j) at the calibrator means;
l) computing the phase compensation φ_{RX, n} from the phase delay φ′_{RX, n} that has been obtained in advance of the calibration procedure and φ″_{RX, n} that is obtained in step k) by a mathematical relation φ_{RX, n}=φ″_{RX, n}−φ′_{RX, n};
m) computing the phase compensations φ_{RX, n} for all n, i.e., {φ_{RX, 1}, . . . , φ_{RX, n}, . . . , φ_{RX, N}} at the calibrator means; and
n) resolving the differences or irregularities in the signal paths associated with each of receiving antenna elements of the array antenna means with the phase compensation values {φ_{RX, 1}, . . . , φ_{RX, n}, . . . , φ_{RX, N}} obtained in step m).

14. A calibration method of an adaptive array antenna system including calibrator means, additional antenna means, and array antenna means with an arbitrary arrangement and spacing—the calibrator means generates the “Rx calibration signal” and performs the calibration procedure based on the “Rx calibration signal” received at each of receiving antenna elements of the array antenna means, the additional antenna means transmits the “Rx calibration signal” to the receiving antenna elements of the array antenna means with an arbitrary arrangement and spacing in a freuqency band of receiving RF (radio frequency), and the array antenna means transfers the “Rx calibration signal” which have been received from the additional antenna means, to the calibrator means—the calibration procedure comprises a step of compensating the differences or irregularities in phase characteristics at each of signal paths associated with each of the receiving antenna elements of the array antenna means utilizing φRX, n (phase delay between each of receiving antenna elements of the array antenna means and each corresponding port of the calibrator means) that is related with the two sets of phase delay values φ″_{RX, n} (phase delay between the additional antenna means and the calibrator means) and φ′_{RX, n} (phase delay between the additional antenna means and each of the receiving antenna elements of the antenna array means) by a mathematical equation
φ_{RX, n}=φ″_{RX, n}−φ′_{RX, n}
where φ′_{RX, n} is obtained in advance of the calibration procedure.

15. The calibration method recited in claim 14, wherein the “Rx calibration signal” can be distinguished by the calibrator means from the other signals that are used by the subscribers during the operation of the array antenna system.

16. The calibration method recited in claim 15, wherein the “Rx calibration signal” is mutually orthogonal to the other signals used by the subscribers during the operation of the array antenna system.

17. The calibration method recited in claim 15, wherein the “Rx calibration signal” is mutually quasi-orthogonal to the other signals used by the subscribers during the operation of the array antenna system.

18. The calibration method recited in claim 14, wherein each of the plural antenna elements of the array antenna means can be used for both receiving and transmitting purpose, and wherein the array antenna system separates each of the receiving and transmitting signal paths that is associated with each of the antenna elements of the array antenna means from each other using duplexer in FDD (frequency division duplexing) array antenna system

19. The calibration method recited in claim 14, wherein each of the plural antenna elements of the array antenna means can be used for both receiving and transmitting purpose, and wherein the array antenna system separates each of the receiving and transmitting signal paths that is associated with each of the antenna elements of the array antenna means from each other using switch in TDD (time division duplexing) array antenna system.

20. The calibration method recited in claim 14, wherein the procedure of computing the phase delay φ′_{RX, n} between the additional antenna means and each of receiving antenna elements of the array antenna means is performed in advance of the calibration procedure of compensating the differences or irregularities in phase characteristics at each of signal paths associated with each of the receiving antenna elements of the array antenna means utilizing the phase delay φ_{RX, n} between each of receiving antenna elements of the array antenna means and each corresponding port of the calibrator means.

21. The calibration method recited in claim 14, wherein the procedure of computing the phase delay φ′_{RX, n} includes the steps of:
a) measuring the phase delay φ_{RX, n} from φ_{RX, n}=φ″_{RX, n}−φ′_{RX, n} where φ″_{RX, n} for n=1, 2, . . . , N is obtained under the condition that the differences among {φ′_{RX, 1}, φ′_{RX, 2}, . . . , φ′_{RX, N}} are removed such that {φ′_{RX, 1}, φ′_{RX, 2}, . . . , φ′_{RX, N}} are all equal to one another, i.e., φ′_{RX, n}=φ′_{RX, m} for 1≦n≦N and 1≦m≦N;
b) measuring the phase delay φ″_{RX, n} between the additional antenna means and the calibarator means without the procedure of removing the differences among the phase delays {φ′_{RX, 1}, φ′_{RX, 2}, . . . , φ′_{RX, N}}; and
c) producing the phase delay φ′_{RX, n} from φ_{RX, n} and φ″_{RX, n} obtained in step a) and b), respectively, in accordance with φ′_{RX, n}=φ″_{RX, n}−φ_{RX, n}.

22. The calibration method recited in claim 21, wherein the step a) is performed by connecting the additional antenna means to each of receiving antenna elements of the array antenna means with wires in such a way that the differences among {φ′_{RX, 1}, φ′_{RX, 2}, . . . , φ′_{RX, N}} are removed.

23. The calibration method recited in claim 21, wherein the step b) includes the steps of:
d) producing the “Rx calibration signal” at the calibrator means;
e)transmitting the “Rx calibration signal” from the additional antenna means to the receving antenna elements of the array antenna means after converting the frequency band of the “Rx calibration signal” to the receiving RF of the array antenna system;
f)feeding the “Rx calibration signal” to the calibrator means by way of the signal paths of each of the receiving antenna elements of the array antenna means, and
g)measuring the phase delay φ″_{RX, n} at the calibrator means from the “Rx calibration signal” obtained in step f).

24. The calibration method recited in claim 14, wherein the calibration procedure of generating the phase compensation φ_{RX, n} (that is the relative phase delay between each of the receiving antenna elements of the array antenna means and the corresponding port of the calibrator means) includes the steps of:
h) generating the “Rx calibration signal” at the calibrator means;
i) transmitting the “Rx calibration signal”, generated in step h), at the additional antenna means to the receving antenna elements of the array antenna means after converting the frequency band of the “Rx calibration signal” from baseband to the receiving RF band of the array antenna system;
j) feeding the “Rx calibration signal” from each of the receivng antenna elements of the array antenna means to the corresponding port of the calibrator means;
k) measuring the phase delay (PRX n from the “Rx calibration signal” obtained in step j) at the calibrator means;
l) computing the phase compensation φ_{RX, n} from the phase delay φ′_{RX, n} that has been obtained in advance of the calibration procedure and φ″_{RX, n} that is obtained in step k) by a mathematical relation φ_{RX, n}=φ″_{RX, n}−φ′_{RX, n};
m) computing the phase compensations φ_{RX, n} for all n, i.e., {φ_{RX, 1}, . . . , φ_{RX, n}, . . . , φ_{RX, N}} at the calibrator means; and
n) resolving the differences or irregularities in the signal paths of each of receiving antenna elements of the array antenna means with the phase compensation values {φ_{RX, 1}, . . . , φ_{RX, n}, . . . , φ_{RX, N}} obtained in step m).

25. A calibration apparatus of an adaptive array antenna system, the calibration apparatus comprising:
calibrator means that generates the “Tx calibration signal” and performs the calibration procedure based on the “Tx calibration signal” received at additional antenna means;
array antenna means with an arbitrary arrangement and spacing of antenna elements that transmits the “Tx calibration signal”, which has been generated at the calibrator means, to the additional antenna means; and
additional antenna means that receives the “Tx calibration signal” from the transmitting antenna elements of the array antenna means with an arbitrary arrangement and spacing in a freuqency band of transmitting RF (radio frequency),
wherein the calibration procedure is performed by a step of compensating the differences or irregularities in phase characteristics at each of signal paths associated with each of the transmitting antenna elements of the array antenna means utilizing φ_{TX, n} (phase delay between calibrator means and each of transmitting antenna elements of the array antenna means and) that is related with the two sets of phase delay values φ″_{TX, n} (phase delay between the calibrator means and the additional antenna means) and φ′_{TX, n} (phase delay between each of the transmitting antenna elements of the antenna array means and the additional antenna means) by a mathematical equation
φ_{TX, n}=φ″_{TX, n}−φ′_{TX, n}
where φ′_{TX, n} is obtained in advance of the calibration procedure.

26. The calibration apparatus recited in claim 25, wherein the “Tx calibration signal” can be distinguished at the calibrator means from the other signals that are used by the subscribers during the operation of the array antenna system.

27. The calibration apparatus recited in claim 25, wherein the “Tx calibration signal” that is transmitted at each of transmitting antenna elements can be distinguished from one another at the calibrator means.

28. The calibration apparatus recited in claim 26, wherein the “Tx calibration signal” is mutually orthogonal to the other signals used by the subscribers during the operation of the array antenna system.

29. The calibration apparatus recited in claim 26, wherein the “Tx calibration signal” is mutually quasi-orthogonal to the other signals used by the subscribers during the operation of the array antenna system.

30. The calibration apparatus recited in claim 25, wherein the additional antenna means receives the “Tx calibration signal” from the transmitting antenna elements of the array antenna means and feeds the “Tx calibration signal” to the calibrator means after converting the frequency band of the “Tx calibration signal” to the base band.

31. The calibration apparatus recited in claim 25, wherein the additional antenna means receives the “Tx calibration signal” from the transmitting antenna elements of the array antenna means and transfers the “Tx calibration signal” to the calibrator means using the receiving signal path assigned to one of the receiving antenna elements of the array antenna means to convert the frequency band of the “Tx calibration signal” to the base band, and wherein the frequency band of the “Tx calibration signal” received at the additional antenna means is converted from the transmitting RF to the receiving RF before the “Tx calibration signal” is fed to said receiving signal path assigned to one of the receiving antenna elements of the array antenna means through a combiner.

32. The calibration apparatus recited in claim 25, wherein each of the plural antenna elements of the array antenna means can be used for both receiving and transmitting purpose, and wherein the array antenna system separates each of the receiving and transmitting signal paths that is associated with each of the antenna elements of the array antenna means from each other using duplexer in FDD (frequency division duplexing) array antenna system.

33. The calibration apparatus recited in claim 25, wherein each of the plural antenna elements of the array antenna means can be used for both receiving and transmitting purpose, and wherein the array antenna system separates each of the receiving and transmitting signal paths that is associated with each of the antenna elements of the array antenna means from each other using switch in TDD (time division duplexing) array antenna system.

34. The calibration apparatus recited in claim 25, wherein the procedure of computing the phase delay φ′_{TX, n} between each of transmitting antenna elements of the array antenna means and the additional antenna means is performed in advance of the calibration procedure of compensating the differences or irregularities in phase characteristics at each of signal paths associated with each of the transmitting antenna elements of the array antenna means utilizing the phase delay φ_{TX, n} between the calibrator means and each of the transmitting antenna elements of the array antenna means.

35. The calibration apparatus recited in claim 25, wherein the procedure of computing the phase delay φ′_{TX, n} includes the steps of:
a) measuring the phase delay φ_{TX, n} from φ_{TX, n}=φ″_{TX, n}−φ′_{TX, n} where φ″_{TX, n} for n=1, 2, . . . , N is obtained under the condition that the differences among {φ′_{TX, 1}, φ′_{TX, 2}, . . . , φ′_{TX, N}} are removed such that {φ′_{TX, 1}, φ′_{TX, 2}, . . . , φ′_{TX, N}} are all equal to one another, i.e., φ′_{TX, n}=φ′_{TX, m} for 1≦n≦N and 1≦m≦N;
b) measuring the phase delay φ″_{TX, n} between the calibarator means and the additional antenna means without the procedure of removing the differences among the phase delays {φ′_{TX, 1}, φ′_{TX, 2}, . . . , φ′_{TX, N}}; and
c) producing the phase delay φ′_{TX, n} from φ_{TX, n} and φ″_{TX, n} obtained in step a) and b), respectively, in accordance with φ′_{TX, n}=φ″_{TX, n}−φ_{TX, n}.

36. The calibration apparatus recited in claim 35, wherein the step a) is performed by connecting the additional antenna means to each of transmitting antenna elements of the array antenna means with wires in such a way that the differences among {φ′_{TX, 1}, φ′_{TX, 2}, . . . , φ′_{TX, N}} are removed.

37. The calibration apparatus recited in claim 35, wherein the step b) includes the steps of:
d) producing the “Tx calibration signal” at the calibrator means;
e) transmitting the “Tx calibration signal” from each of the transmitting antenna elements of the array antenna means to the additional antenna means in the frequency band of the transmitting RF of the array antenna system;
f) feeding the “Tx calibration signal” to the calibrator means after converting the frequency band of the “Tx calibration signal” to the base band, and
g) measuring the phase delay φ″_{TX, n} at the calibrator means from the “Tx calibration signal” obtained in step f).

38. The calibration apparatus recited in claim 25, wherein the calibration procedure of generating the phase compensation φ_{TX, n} (that is the relative phase delay between each port of the calibrator means” and each of the corresponding transmitting antenna elements of the array antenna means) includes the steps of:
h) generating the “Tx calibration signal” at the calibrator means;
i) transmitting the “Tx calibration signal”, generated in step h), at each of the transmitting antenna elements of the array antenna means to the additional antenna means in the frequency band of the transmitting RF band of the array antenna system;
j) transferring the “Tx calibration signal” which has been received at the additional antenna means, to the corresponding port of the calibrator means in the frequency band of base band;
k) computing the phase delay φ″_{TX, n} between the calibrator and the additional antenna means at the calibrator from the “Tx calibration signal” received through the additional antenna means in step j);
l) computing the phase compensation φ_{TX, n} from the phase delay φ′_{TX, n} that has been obtained in advance of the calibration procedure and φ″_{TX, n} that is obtained in step k) by a mathematical relation φ_{TX, n}=φ″_{TX, n}−φ′_{TX, n};
m) computing the phase compensations φ_{TX, n} for all n, i.e., {φ_{TX, 1}, . . . , φ_{TX, n}, . . . , φ_{TX, N}} at the calibrator means; and
n) resolving the differences or irregularities in the signal paths associated with each of transmitting antenna elements of the array antenna means with the phase compensation values {φ_{TX, 1}, . . . , φ_{TX, n}, . . . , φ_{TX, N}} obtained in step m).

39. A calibration method of an adaptive array antenna system including calibrator means, additional antenna means, and array antenna means with an arbitrary arrangement and spacing—the calibrator means generates the “Tx calibration signal” and performs the calibration procedure based on the “Tx calibration signal” received at the additional antenna means, each of the transmitting antenna elements of the array antenna means transmits the “Tx calibration signal” to the additional antenna means in a freuqency band of transmitting RF (radio frequency) of the array antenna system, and the “Tx calibration signal” received at the additional antenna means is transferred to the calibrator means after the frequency band is converted from the transmitting RF to the base band—the calibration procedure comprises a step of compensating the differences or irregularities in phase characteristics at each of signal paths associated with each of the receiving antenna elements of the array antenna means utilizing φ_{TX, n} (phase delay between each of receiving antenna elements of the array antenna means and each corresponding port of the calibrator means) that is related with the two sets of phase delay values φ″_{TX, n} (phase delay between the additional antenna means and the calibrator means) and φ′_{TX, n} (phase delay between the additional antenna means and each of the receiving antenna elements of the antenna array means) by a mathematical equation
φ_{TX, n}=φ″_{TX, n}−φ′_{TX, n}
where φ′_{TX, n} is obtained in advance of the calibration procedure.

40. The calibration method recited in claim 39, wherein the “Tx calibration signal” can be distinguished at the calibrator means from the other signals that are used by the subscribers during the operation of the array antenna system.

41. The calibration method recited in claim 40, wherein the “Tx calibration signal” is mutually orthogonal to the other signals used by the subscribers during the operation of the array antenna system.

42. The calibration method recited in claim 40, wherein the “Tx calibration signal” is mutually quasi-orthogonal to the other signals used by the subscribers during the operation of the array antenna system.

43. The calibration method recited in claim 39, wherein each of the plural antenna elements of the array antenna means can be used for both receiving and transmitting purpose, and wherein the array antenna system separates each of the receiving and transmitting signal paths that is associated with each of the antenna elements of the array antenna means from each other using duplexer in FDD (frequency division duplexing) array antenna system.

44. The calibration method recited in claim 39, wherein each of the plural antenna elements of the array antenna means can be used for both receiving and transmitting purpose, and wherein the array antenna system separates each of the receiving and transmitting signal paths that is associated with each of the antenna elements of the array antenna means from each other using switch in TDD (time division duplexing) array antenna system.

45. The calibration method recited in claim 39, wherein the procedure of computing the phase delay φ′_{TX, n} between each of transmitting antenna elements of the array antenna means and the additional antenna means is performed in advance of the calibration procedure of compensating the differences or irregularities in phase characteristics at each of signal paths associated with each of the transmitting antenna elements of the array antenna means utilizing the phase delay φ_{TX, n} between the calibrator means and each of the transmitting antenna elements of the array antenna means.

46. The calibration method recited in claim 39, wherein the procedure of computing the phase delay φ′_{TX, n} includes the steps of:
a) measuring the phase delay φ_{TX, n} from φ_{TX, n}=φ″_{TX, n}−φ′_{TX, n} where φ″_{TX, n} for n=1, 2, . . . , N is obtained under the condition that the differences among {φ′_{TX, 1}, φ′_{TX, 2}, . . . , φ′_{TX, N}} are removed such that {φ′_{TX, 1}, φ′_{TX, 2}, . . . , φ′_{TX, N}} are all equal to one another, i.e., φ′_{TX, n}=φ′_{TX, m} for 1≦n≦N and 1≦m≦N;
b) measuring the phase delay φ″_{TX, n} between the additional antenna means and the calibarator means without the procedure of removing the differences among the phase delays {φ′_{TX, 1}, φ′_{TX, 2}, . . . , φ′_{TX, N}}; and
c) producing the phase delay φ′_{TX, n} from φ_{TX, n} and φ″_{TX, n} obtained in step a) and b), respectively, in accordance with φ′_{TX, n}=φ″_{TX, n}−φ_{TX, n}.

47. The calibration method recited in claim 46, wherein the step a) is performed by connecting the additional antenna means to each of transmitting antenna elements of the array antenna means with wires in such a way that the differences among {φ′_{TX, 1}, φ′_{TX, 2}, . . . , φ′_{TX, N}} are removed.

48. The calibration method recited in claim 46, wherein the step b) includes the steps of:
d) producing the “Tx calibration signal” at the calibrator means;
e) transmitting the “Tx calibration signal” from each of the transmitting antenna elements of the array antenna means to the additional antenna means in the frequency band of the transmitting RF of the array antenna system;
f) feeding the “Tx calibration signal” to the calibrator means after converting the frequency band of the “Tx calibration signal” to the base band, and
g)measuring the phase delay φ″_{TX, n} at the calibrator means from the “Tx calibration signal” obtained in step f).

49. The calibration means recited in claim 39, wherein the calibration procedure of generating the phase compensation φ_{TX, n} (that is the relative phase delay between each port of the calibrator means and each of the corresponding transmitting antenna elements of the array antenna means) includes the steps of:
h) generating the “Tx calibration signal” at the calibrator means;
i) transmitting the “Tx calibration signal”, generated in step h), at each of the transmitting antenna elements of the array antenna means to the additional antenna means in the frequency band of the transmitting RF band of the array antenna system;
j) transferring the “Tx calibration signal”, which has been received at the additional antenna means, to the corresponding port of the calibrator means in the frequency band of base band;
k) computing the phase delay φ″_{TX, n} between the calibrator and the additional antenna means at the calibrator from the “Tx calibration signal” received through the additional antenna means in step j);
l) computing the phase compensation φ_{TX, n} from the phase delay φ′_{TX, n} that has been obtained in advance of the calibration procedure and φ″_{TX, n} that is obtained in step k) by a mathematical relation φ_{TX, n}=φ″_{TX, n}−φ′_{TX, n};
m) computing the phase compensations φ_{TX, n} for all n, i.e., {φ_{TX, 1}, . . . , φ_{TX, n}, . . . , φ_{TX, N}} at the calibrator means; and
n) resolving the differences or irregularities in the signal paths associated with each of transmitting antenna elements of the array antenna means with the phase compensation values {φ_{TX, 1}, . . . , φ_{TX, n}, . . . , φ_{TX, N}} obtained in step m).
